(19) United States
(12) Patent Application Publication
(10) Pub. No.: US 2021/0110979 A1
(43) Pub. Date: Apr. 15, 2021

(54) ULTRA-HIGH POWER HYBRID CELL DESIGN WITH UNIFORM THERMAL DISTRIBUTION

(71) Applicant: GM GLOBAL TECHNOLOGY OPERATIONS LLC, Detroit, MI (US)

(72) Inventors: Xiaochao QUE, Shanghai (CN); Dave G. RICH, Sterling Heights, MI (US); Haijing LIU, Shanghai (CN); Dewen KONG, Shanghai (CN)

(73) Assignee: GM GLOBAL TECHNOLOGY OPERATIONS LLC, Detroit, MI (US)

(21) Appl. No.: 16/786,453

(22) Filed: Feb. 10, 2020

(30) Foreign Application Priority Data
Oct. 15, 2019 (CN) 201910977475.9

(51) Int. Cl. H01G 11/06; H01G 11/50; H01G 11/34; H01G 11/66; H01M 4/133; H01M 12/02; H01M 10/0525

(52) U.S. Cl. CPC H01G 11/06; H01G 11/50; H01G 11/34; H01M 10/0525; H01M 4/133; H01M 12/02; H01G 11/66

(57) ABSTRACT

A capacitor-assisted hybrid lithium-ion electrochemical cell assembly includes two positive electrodes having a first polarity, each having at least two electrically conductive tabs disposed on at least one first edge and at least one second edge. Further, two negative electrodes having a second polarity each having at least two electrically conductive tabs disposed on at least one first edge and at least one second edge. At least one of the two positive electrodes or negative electrodes are distinct from one another. The electrically conductive tabs are substantially aligned in the electrochemical cell to respectively define a plurality of positive electrical connectors and a plurality of negative electrical connectors to reduce current density during high power charging and discharging.

### CROSS-REFERENCE TO RELATED APPLICATIONS

This application claims the benefit and priority of Chinese Patent Application No. 201910977475.9, filed Oct. 15, 2019. The entire disclosure of the above application is incorporated herein by reference.

### INTRODUCTION

This section provides background information related to the present disclosure which is not necessarily prior art.

The present disclosure relates to hybrid lithium-ion electrochemical cells having high-energy capacity and high power capacity. Such, capacitor-assisted hybrid lithium-ion electrochemical cells include an assembly of electrodes each having a plurality of conductive tabs on distinct edges that form positive and negative electrical connectors on multiple edges of the capacitor-assisted lithium-ion electrochemical cell to reduce current density and improve thermal management.

High-energy density electrochemical cells, such as lithium-ion batteries can be used in a variety of consumer products and vehicles, such as hybrid or electric vehicles. Typical lithium-ion batteries comprise at least one positive electrode or cathode, at least one negative electrode or an anode, an electrolyte material, and a separator. A stack of lithium-ion battery cells may be electrically connected in an electrochemical device to increase overall output. Lithium-ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery. Each of the negative and positive electrodes within a stack is connected to a current collector (typically a metal, such as copper foil for the anode and aluminum foil for the cathode). During battery usage, the current collectors associated with the two electrodes are connected by an external circuit that allows current generated by electrons to pass between the electrodes to compensate for transport of lithium ions.

The potential difference or voltage of a battery cell is determined by differences in chemical potentials (e.g., Fermi energy levels) between the electrodes. Under normal operating conditions, the potential difference between the electrodes achieves a maximum achievable value when the battery cell is fully charged and a minimum achievable value when the battery cell is fully discharged. The battery cell will discharge and the minimum achievable value will be obtained when the electrodes are connected to a load performing the desired function (e.g., electric motor) via an external circuit. Each of the negative and positive electrodes in the battery cell is connected to a current collector (typically a metal, such as copper for the anode and aluminum for the cathode). The current collectors associated with the two electrodes are connected by an external circuit that allows current generated by electrons to pass between the electrodes to compensate for transport of lithium ions across the battery cell. For example, during cell discharge, the internal Li⁺ ionic current from the negative electrode to the positive electrode may be compensated by the electronic current flowing through the external circuit from the negative electrode to the positive electrode of the battery cell.

Many different materials may be used to create components for a lithium ion battery. For example, positive electrode materials for lithium batteries typically comprise an electroactive material which can be intercalated or reacted with lithium ions, such as lithium-transition metal oxides or mixed oxides, for example including LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or one or more phosphate compounds, for example including lithium iron phosphate or mixed lithium manganese-iron phosphate. The negative electrode typically includes a lithium insertion material or an alloy host material. For example, typical electroactive materials for forming an anode include graphite and other forms of carbon, silicon and silicon oxide, lithium titanate (Li₄Ti₅O₁₂), tin and tin alloys.

One approach to increase the power of lithium-ion electrochemical cells is to create systems that include electrodes with both a high energy capacity electroactive material and a high power capacity electroactive material (for example, a first positive electrode comprising a high energy capacity electroactive material and a second positive electrode comprising a high power capacity electroactive material). Energy capacity or density is an amount of energy the battery can store with respect to its mass (watt-hours per kilogram (Wh/kg)). Power capacity or density is an amount of power that can be generated by the battery with respect to its mass (watts per kilogram (W/kg)). These hybrid cells may be referred to as capacitor-assisted lithium-ion batteries. However, including high power capacity materials can result in higher charges and pose potential thermal management issues during charging and discharging of the electrochemical device. It would be advantageous to develop high power hybrid lithium-ion cells, which along with high power capacity and high energy capacity, also have uniform current density and good thermal distribution.

### SUMMARY

This section provides a general summary of the disclosure, and is not a comprehensive disclosure of its full scope or all of its features.

In certain aspects, the present disclosure relates to a capacitor-assisted hybrid lithium-ion electrochemical cell assembly that includes a first positive electrode having a first polarity and at least two first electrically conductive tabs disposed on at least one first edge of the first positive electrode and at least one second edge distinct from the first edge. The capacitor-assisted hybrid lithium-ion electrochemical cell assembly also include a second positive electrode having the first polarity and at least two second electrically conductive tabs disposed on at least one first edge of the second positive electrode and at least one second edge distinct from the first edge. A third negative electrode having a second polarity opposite to the first polarity is also included having at least two third electrically conductive tabs disposed on at least one first edge of the third negative electrode and at least one second edge distinct from the first edge. A fourth negative electrode having the second polarity and at least two fourth electrically conductive tabs is disposed on at least one first edge of the fourth negative electrode and at least one second edge distinct from the first edge. In certain variations, the second positive electrode includes a distinct active material from the first positive electrode. In other variations, the fourth negative electrode includes a distinct active material from the third negative electrode. The at least two first electrically conductive tabs and the at least two second electrically conductive tabs are substantially aligned in the electrochemical cell assembly to respectively define a plurality of positive electrical connectors. Similarly, the at least two third electrically conductive tabs and the at least two fourth electrically conductive tabs are substantially aligned in the electrochemical cell assembly to define a plurality of negative electrical connectors spaced apart from the plurality of positive electrical connectors to reduce current density during high power charging and discharging.

In one aspect, the at least one first edge of the first positive electrode has a first length and the at least one second edge has a second length greater than the first length. Further, the at least one first edge of the second positive electrode has the first length and the at least one second edge has the second length. The at least one first edge of the third negative electrode has the first length and the at least one second edge has the second length. The at least one first edge of the fourth negative electrode has the first length and the at least one second edge has the second length. The first positive electrode, the second positive electrode, the third negative electrode, and the fourth negative electrode are assembled together to form the capacitor-assisted hybrid lithium-ion electrochemical cell assembly defining a first cell edge with the first length and a second cell edge with the second length. At least one of the plurality of positive electrical connectors and at least one of the negative electrical connectors is disposed on the first cell edge. Further, at least one of the plurality of positive electrical connectors and at least one of the negative electrical connectors is disposed on the second cell edge of the capacitor-assisted hybrid lithium-ion electrochemical cell assembly.

In one aspect, either the first positive electrode or third negative electrode includes a high energy capacity electroactive material. Further, the second positive electrode or the fourth negative electrode includes a high power capacity electroactive material. The first positive electrode and the third negative electrode define a lithium-ion battery. The second positive electrode and/or the fourth negative electrode define a capacitor.

In one aspect, the at least two first electrically conductive tabs include four first electrically conductive tabs disposed on each of four edges of the first positive electrode. The at least two second electrically conductive tabs include four second electrically conductive tabs disposed on each of four edges of the second positive electrode. The at least two third electrically conductive tabs include four third electrically conductive tabs disposed on each of four edges of the third negative electrode. The at least two fourth electrically conductive tabs include four fourth electrically conductive tabs disposed on each of four edges of the fourth negative electrode. The electrochemical cell assembly defines four cell edges that each include a positive electrical connector and a negative electrical connector.

In one aspect, the at least two first electrically conductive tabs include three first electrically conductive tabs disposed on each of three edges of the first positive electrode. The at least two second electrically conductive tabs include three second electrically conductive tabs disposed on each of three edges of the second positive electrode. The at least two third electrically conductive tabs include three third electrically conductive tabs disposed on each of three edges of the third negative electrode. The at least two fourth electrically conductive tabs include three fourth electrically conductive tabs disposed on each of three edges of the fourth negative electrode. The electrochemical cell assembly defines: (i) three cell edges including both a positive electrical connector and a negative electrical connector or (ii) a first cell edge having a positive electrical connector and a negative electrical connector, a second cell edge having a positive electrical connector and a negative electrical connector, a third cell edge having a positive electrical connector, and a fourth cell edge having a negative electrical connector.

In one aspect, the at least two first electrically conductive tabs include three electrically conductive tabs disposed on three edges of the first positive electrode and the at least two second electrically conductive tabs include three electrically conductive tabs disposed on three edges of the second positive electrode.

In one aspect, the at least two third electrically conductive tabs include three electrically conductive tabs disposed on three edges of the third negative electrode. The at least two fourth electrically conductive tabs include three electrically conductive tabs disposed on three edges of the third negative electrode.

In one aspect, a maximum current density is less than or equal to about 300 mA/cm² for at least one of the first electrode, the second electrode, the third electrode, or the fourth electrode.

In one aspect, the first positive electrode includes a first electroactive material selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof.

In one aspect, the second positive electrode includes a second electroactive material and the fourth negative electrode includes a fourth electroactive material. At least one of the second electroactive material and/or the fourth electroactive material is selected from the group consisting of: silicon oxide, activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, RuO₂, transition metals, hydroxides of transition metals, MnO₂, NiO, Co₃O₄, Co(OH)₂, Ni(OH)₂, polyaniline (PANI), polypyrrole (PPy), polythiophene (PTh), and combinations thereof.

In one aspect, the third negative electrode includes a third negative electrode material selected from the group consisting of: lithium metal, lithium alloy, silicon (Si), silicon alloy, silicon oxide, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In one aspect, each of the first positive electrode, the second positive electrode, the third negative electrode and the fourth negative electrode respectively includes a current collector having an electroactive layer disposed thereon. A portion of the current collector defines the plurality of electrically conductive tabs.

In one aspect, the electrochemical cell assembly includes at least three positive electrical connectors and at least three negative electrical connectors.

In certain other aspects, the present disclosure relates to a capacitor-assisted hybrid lithium-ion electrochemical cell assembly that includes a first positive electrode having a first polarity and at least two first electrically conductive tabs disposed on at least one first edge and at least one a second adjoining edge. A second positive electrode having the first polarity is also included having a distinct active material from the first positive electrode, and at least two second electrically conductive tabs disposed on at least one first edge and at least one second adjoining edge. A third negative electrode is also included having a second polarity opposite to the first polarity and at least two third electrically conductive tabs disposed on at least one first edge and at least one second adjoining edge. A fourth negative electrode having the second polarity and at least two fourth electrically conductive tabs disposed on at least one first edge and at least one second adjoining edge is also provided. The at least two first electrically conductive tabs and the at least two second electrically conductive tabs are substantially aligned in the electrochemical cell assembly to respectively define a plurality of positive electrical connectors. Further, the at least two third electrically conductive tabs and the at least two fourth electrically conductive tabs are substantially aligned in the electrochemical cell assembly to define a plurality of negative electrical connectors spaced apart from the plurality of positive electrical connectors to reduce current density during high power charging and discharging.

In one aspect, either the first positive electrode or third negative electrode includes a high energy capacity electroactive material. The second positive electrode or the fourth negative electrode includes a high power capacity electroactive material. The first positive electrode or and the third negative electrode define a lithium-ion battery and the second positive electrode and/or the fourth negative electrode define a capacitor.

In one aspect, at least two first electrically conductive tabs include three electrically conductive tabs disposed on three edges of the first positive electrode. The at least two second electrically conductive tabs include three electrically conductive tabs disposed on three edges of the second positive electrode.

In one aspect, the at least two third electrically conductive tabs include three electrically conductive tabs disposed on three edges of the third negative electrode. The at least two fourth electrically conductive tabs include three electrically conductive tabs disposed on three edges of the third negative electrode.

In one aspect, the first positive electrode includes a first electroactive material selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof. The third negative electrode includes a third negative electrode material selected from the group consisting of: lithium metal, lithium alloy, silicon (Si), silicon alloy, silicon oxide, activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof. The second positive electrode includes a second electroactive material and the fourth negative electrode includes a fourth electroactive material, wherein at least one of the second electroactive material and/or the fourth electroactive material is selected from the group consisting of: silicon oxide, activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, RuO₂, transition metals, hydroxides of transition metals, MnO₂, NiO, Co₃O₄, Co(OH)₂, Ni(OH)₂, polyaniline (PANI), polypyrrole (PPy), polythiophene (PTh), and combinations thereof.

In yet other aspects, the present disclosure relates to a capacitor-assisted hybrid lithium-ion electrochemical cell assembly. The assembly includes a first positive electrode having a first polarity and at least two first electrically conductive tabs disposed on at least one first edge of the first positive electrode and at least one second edge distinct from the first edge. A second positive electrode having the first polarity is provided with at least two second electrically conductive tabs disposed on at least one first edge of the second positive electrode and at least one second edge distinct from the first edge. Also included is a third negative electrode having a second polarity opposite to the first polarity and at least two third electrically conductive tabs disposed on at least one first edge of the third negative electrode and at least one second edge distinct from the first edge. A fourth negative electrode has the second polarity and at least two fourth electrically conductive tabs disposed on at least one first edge of the fourth negative electrode and at least one second edge distinct from the first edge. Either the first positive electrode or third negative electrode includes a high energy capacity electroactive material and the second positive electrode or the fourth negative electrode includes a high power capacity electroactive material. The at least two first electrically conductive tabs and the at least two second electrically conductive tabs are substantially aligned in the electrochemical cell assembly to respectively define at least one positive electrical connector. The at least two third electrically conductive tabs and the at least two fourth electrically conductive tabs are substantially aligned in the electrochemical cell assembly to define at least one negative electrical connector to reduce current density during high power charging and discharging.

In one aspect, the electrochemical cell assembly has at least one cell edge including both a positive electrical connector and spaced apart negative electrical connector.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1B. FIG. 1A shows current distribution in a single high power lithium-ion pouch cell. FIG. 1B shows a more detailed exploded view of various components in a lithium-ion electrochemical cell showing current flowing from a negative electrode to a positive electrode during discharging.

FIG. 2 shows a thermal image of a lithium-ion pouch cell discharging at a 5 C rate in ambient air reproduced based on data from the Journal of the Electrochemical Society, 161 (14) pp. A2168-A2174 (2014) showing high levels of heat generated near the positive electrode.

FIG. 3 is a schematic illustration of a simplified example of a capacitor-assisted lithium-ion battery in accordance with various aspects of the present disclosure.

FIGS. 4A-4B. FIG. 4A shows components of a capacitor-assisted hybrid lithium-ion electrochemical cell assembly prepared in accordance with certain aspects of the present disclosure having electrode components with tabs on four distinct edges. FIG. 4B shows a schematic of a capacitor-assisted hybrid lithium-ion electrochemical cell assembly having a plurality of positive electrical connectors and a plurality of negative electrical connectors, where each edge of electrochemical cell assembly has a positive electrical connector and a spaced apart negative electrical connector.

FIG. 5 shows exploded view of various components in a capacitor-assisted hybrid lithium-ion electrochemical cell assembly prepared in accordance with certain aspects of the present disclosure like that in FIGS. 4A-4B, showing current distribution.

FIGS. 6A-6B. FIG. 6A shows components of a capacitor-assisted hybrid lithium-ion electrochemical cell assembly prepared in accordance with certain aspects of the present disclosure having electrode components with tabs on three distinct edges. FIG. 6B shows a schematic of a capacitor-assisted hybrid lithium-ion electrochemical cell assembly having a plurality of positive electrical connectors and a plurality of negative electrical connectors, where three edges of electrochemical cell assembly have a positive electrical connector and a spaced apart negative electrical connector.

FIGS. 7A-7B. FIG. 7A shows components of a capacitor-assisted hybrid lithium-ion electrochemical cell assembly prepared in accordance with certain aspects of the present disclosure having electrode components with tabs on three distinct edges. FIG. 7B shows a schematic of a capacitor-assisted hybrid lithium-ion electrochemical cell assembly having a plurality of positive electrical connectors and a plurality of negative electrical connectors, where two edges of electrochemical cell assembly have a positive electrical connector and a spaced apart negative electrical connector, one edge has a positive electrical connector, and one edge has a negative electrical connector.

FIGS. 8A-8B. FIG. 8A shows components of a capacitor-assisted hybrid lithium-ion electrochemical cell assembly prepared in accordance with certain aspects of the present disclosure having electrode components with tabs on two distinct edges. FIG. 8B shows a schematic of a capacitor-assisted hybrid lithium-ion electrochemical cell assembly having a plurality of positive electrical connectors and a plurality of negative electrical connectors, where two opposite edges of electrochemical cell assembly have a positive electrical connector and a spaced apart negative electrical connector.

FIGS. 9A-9B. FIG. 9A shows components of a capacitor-assisted hybrid lithium-ion electrochemical cell assembly prepared in accordance with certain aspects of the present disclosure having electrode components with tabs on two distinct, but adjoining edges. FIG. 9B shows a schematic of a capacitor-assisted hybrid lithium-ion electrochemical cell assembly having a plurality of positive electrical connectors and a plurality of negative electrical connectors, where one edge has a positive electrical connector and a spaced apart negative electrical connector, a first adjoining edge has a positive electrical connector, and a second adjoining edge has a negative electrical connector, such that the first adjoining edge and second adjoining edge are opposite to one another.

FIGS. 10A-10B. FIG. 10A shows components of a capacitor-assisted hybrid lithium-ion electrochemical cell assembly prepared in accordance with certain aspects of the present disclosure having electrode components with continuous L-shaped tabs on two adjoining edges. FIG. 10B shows a schematic of a capacitor-assisted hybrid lithium-ion electrochemical cell assembly having a plurality of positive electrical connectors and a plurality of negative electrical connectors, where a first edge has a positive electrical connector, an adjoining second edge has a negative electrical connector, a third edge has negative electrical connector, and a fourth edge has a positive electrical connector; so that a first pair of opposite edges have a positive electrical connector and an opposite negative electrical connector and a second pair of opposite edges also have a positive electrical connector and an opposite negative electrical connector.

FIGS. 11A-11B. FIG. 11A shows components of a capacitor-assisted hybrid lithium-ion electrochemical cell assembly prepared in accordance with certain aspects of the present disclosure having positive electrode components with tabs on two distinct opposing edges and negative electrode components with tabs on two distinct opposing edges. FIG. 11B shows a schematic of a capacitor-assisted hybrid lithium-ion electrochemical cell assembly having a plurality of positive electrical connectors and a plurality of negative electrical connectors, where a first edge has a positive electrical connector, an adjoining second edge has a negative electrical connector, a third edge has a positive electrical connector, and a fourth edge has a negative electrical connector; so that a first pair of opposite edges have a positive electrical connector and an opposite positive electrical connector and a second pair of opposite edges also have a negative electrical connector and an opposite negative electrical connector.

FIGS. 12A-12B. FIG. 12A shows components of a capacitor-assisted hybrid lithium-ion electrochemical cell assembly prepared in accordance with certain aspects of the present disclosure having positive electrode components with tabs on two distinct opposing edges and negative electrode components with single tabs on one edge. FIG. 12B shows a schematic of a capacitor-assisted hybrid lithium-ion electrochemical cell assembly having a plurality of positive electrical connectors and a negative electrical connector, where a first edge has a positive electrical connector, an adjoining second edge has a negative electrical connector, and a third edge has a positive electrical connector.

FIGS. 13A-13B. FIG. 13A shows components of a capacitor-assisted hybrid lithium-ion electrochemical cell assembly prepared in accordance with certain aspects of the present disclosure having positive electrode components with a tab on a single edge and negative electrode components with tabs on two distinct opposing edges. FIG. 13B shows a schematic of a capacitor-assisted hybrid lithium-ion electrochemical cell assembly having a plurality of negative electrical connectors and a positive electrical connector, where a first edge has a negative electrical connector, an adjoining second edge has a positive electrical connector, and a third edge has a negative electrical connector.

FIGS. 14A-14B. FIG. 14A shows components of a prismatic lithium-ion capacitor-assisted hybrid lithium-ion electrochemical cell assembly prepared in accordance with certain aspects of the present disclosure having with continuous L-shaped tabs on two adjoining edges of the positive electrode components and with continuous L-shaped tabs on two adjoining edges of the negative electrode components. FIG. 14B shows assembly of the stack of component in FIG. 14B to form a battery core having a pair of opposite edges have a positive electrical connector and an opposite negative electrical connector, along with cooling foils on edges not having the positive or negative electrical connector.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

One approach to increase the power of lithium-ion electrochemical cells is to create systems that include electrodes with both a high energy capacity electroactive material and a high power capacity electroactive material (for example, a first positive electrode comprising a high energy capacity electroactive material and a second positive electrode comprising a high power capacity electroactive material). Energy capacity or density is an amount of energy the battery can store with respect to its mass (watt-hours per kilogram (Wh/kg)). Power capacity or density is an amount of power that can be generated by the battery with respect to its mass (watts per kilogram (W/kg)). Such high power active materials are integrated into and can thus be used to create a capacitor within the lithium-ion electrochemical cell.

Thus, the present technology pertains to electrochemical cells including capacitors or hybrid supercapacitor-battery systems (e.g., capacitor-assisted batteries (“CAB”)), which integrate the high power density of capacitors with high energy density of lithium-ion batteries, that may be used in, for example, automotive or other vehicles (e.g., motorcycles, boats), but may also be used in a variety of other industries and applications, such as consumer electronic devices, by way of non-limiting example.

However, including high power capacity materials can result in higher charges and pose potential thermal management issues during charging and discharging of the electrochemical device. High power performance of Li-ion cells may be limited by current flow within electrodes, especially for hybrid capacitor-assisted battery designs that have instantaneously high power boost/regeneration. During high current charge or discharge, large temperature/thermal gradients can be observed. Increasing thermal gradients may lead to inconsistency ageing status of each electrode thus may affect cell durability.

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected (e.g., in a stack) to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form.

In hybrid capacitor-battery systems (e.g., capacitor-assisted batteries), a capacitor may be integrated with the lithium-ion battery or cell stack. A capacitor may include one or more capacitor components or layers, such as a positive electrode or cathode that can function as a capacitor in conjunction with a corresponding negative electrode or anode, that are parallel or stacked with the one or more electrodes that form the lithium-ion battery. The one or more capacitor components or layers may be integrated within a housing defining the lithium-ion battery or stack, such that a capacitor component is also in communication with the electrolyte of the lithium-ion battery. Each of the negative and positive electrodes and capacitor components within a hybrid battery pack or cell stack may be connected to a current collector (typically a metal, such as copper for the anode and/or capacitor-assisted anode and aluminum for the cathode and/or capacitor-assisted cathode). During battery usage, the current collectors associated with the (stacked) electrodes are connected by an external circuit that allows current generated by electrons to pass between the electrodes to compensate for transport of lithium ions.

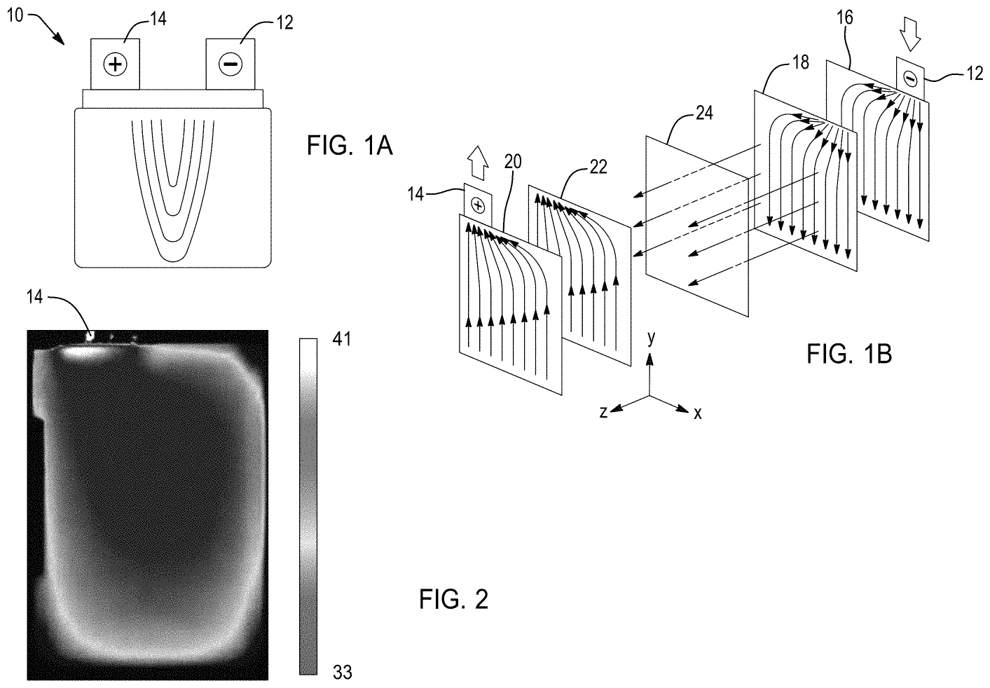

By way of background, FIGS. 1A-1B show current distribution in a single high power lithium-ion pouch cell 10 like that described in Electrochimica Acta, 133 pp. 197-208 (2014), the relevant portions of which are incorporated herein by reference. As can be seen, the current flows between a negative electrode tab 12 and a positive electrode tab 14. As shown in FIG. 1B, a simplified lithium-ion battery is shown with planar electrodes that can be assembled together. The negative electrode tab 12 is electrically connected to an internal negative current collector 16 and negative electrode active layer 18 that together define a negative electrode. Likewise, the positive electrode tab 14 is electrically connected to an internal negative current collector 20 and positive electrode active layer 22 that together define a positive electrode. The positive and negative electrodes are electrically isolated from one another by a porous separator 24. As can be seen, the current flow is generally concentrated in areas near the positive electrode tab 14 and negative electrode tab 12. The arrows in the z-direction generally correspond to reaction current and transport of lithium ions (Li⁺) from the negative electrode to the positive electrode during a discharge process. The arrows in the x-y planes are current flowpath on the electrodes as current flowing from the negative electrode to the positive electrode during discharging.

FIG. 2 shows thermal imaging of a lithium-ion pouch cell discharging at a 5 C rate in ambient air reproduced based on data from the Journal of the Electrochemical Society, 161 (14) pp. A2168-A2174 (2014), the relevant portions of which are incorporated herein by reference, showing high levels of heat generated near the positive electrode tab 14. The y-axis is temperature ranging from 33° C. to 41° C. The C-rate is a rate at which a lithium-ion battery discharges relative to its maximum capacity, where a rate of 1 C is also known as a one-hour discharge and a discharge of 5 C is full discharge in about 12 minutes. As can be seen, uneven thermal distribution is observed during high power operations of the lithium-ion electrochemical cell, where under certain conditions, the positive electrode tab 14 electrical connector may be the hottest area. During high current charging or discharging, undesirable temperature/thermal gradients can be observed. As thermal gradients within the electrochemical cell increase, this may lead to inconsistent ageing of each electrode, which could affect cell durability. As such, high power performance of lithium-ion hybrid electrochemical cells is limited by thermal regulation and current flow within electrodes, especially for hybrid capacitor-assisted battery designs providing instantaneously high power boost and regeneration or recharging. As used herein, high power charging and discharging may be considered to be a charge or discharge rate of greater than or equal to 5 C to less than or equal to about 50 C for a period of greater than or equal to about 0.05 seconds to less than or equal to about 30 seconds.

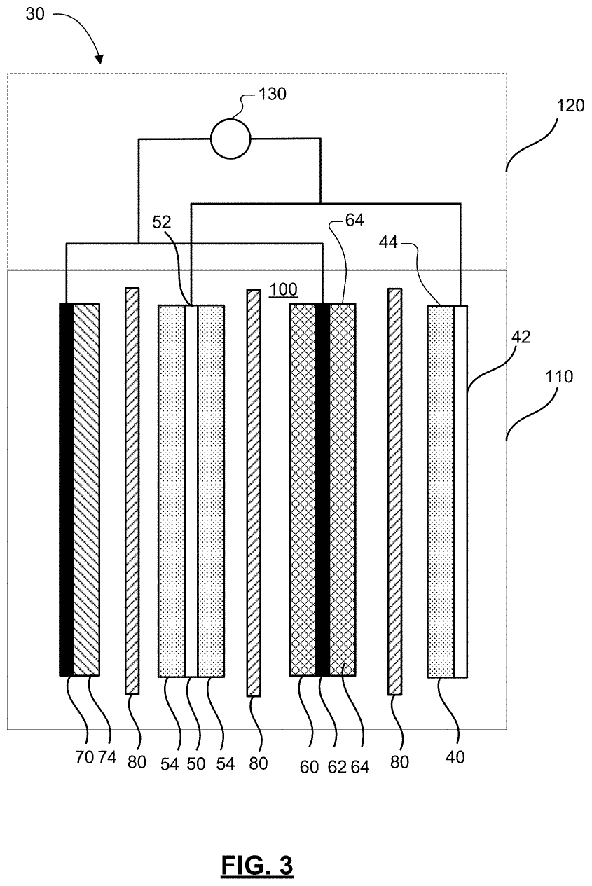

FIG. 3 shows an exemplary schematic illustration of a capacitor-assisted lithium-ion electrochemical cell (e.g. battery) 30. The capacitor-assisted battery 30 includes at least two positive electrodes 40, 50 and at least two negative electrodes 60, 70. The capacitor-assisted battery 30 may further includes an electrolyte 100. A first positive electrode 40 may be parallel to a second positive electrode 50 and a negative electrode 60 may be disposed therebetween. A second negative electrode 70 may be parallel to a side or surface of the second positive electrode 50 that opposes the negative electrode 60. Each of the electrodes 40, 50, 60, 70 may have a porous separator 80 disposed therebetween to provide electrical separation between electrodes of opposite polarities. In designs with liquid electrolyte, the electrochemical cell 30 includes a separator structure. However, in certain solid electrolyte designs, no separator 80 may be necessary in the electrochemical cell, as the solid electrolyte may serve the role of both electrical insulator and ion conductor.

In certain aspects, as shown, the electrodes 40, 50, 60, 70 may be disposed within a single battery housing 110 containing an electrolyte 100. The skilled artisan will appreciate, however, that in various other aspects, other housing systems or designs may be present. For example, in certain variations, the first positive electrode 40 and the negative electrode 60 may be disposed within a first housing (e.g., a battery housing) having a first electrolyte, and the second positive electrode 50 and the second negative electrode 70 may be disposed within a second housing (e.g., capacitor housing) having a second electrolyte. In such instances, the first electrolyte may be the same or different from the second electrolyte.

In various aspects, the capacitor-assisted battery 30 may include greater than or equal to about 1 wt. % to less than or equal to about 25 wt. %, and in certain aspects, optionally greater than or equal to about 3 wt. % to less than or equal to about 20 wt. %, of the electrolyte 100. Any appropriate electrolyte 100, whether in solid, liquid, or gel form, capable of conducting lithium ions between the electrodes 40, 50, 60, 70 may be used in the capacitor-assisted battery 30. For example, the electrolyte 100 may be a non-aqueous liquid electrolyte solution that includes a lithium salt dissolved in an organic solvent or a mixture of organic solvents. Numerous conventional non-aqueous liquid electrolyte solutions may be employed in the capacitor-assisted battery 30.

Appropriate lithium salts generally include inert anions. A non-limiting list of lithium salts that may be dissolved in an organic solvent or a mixture of organic solvents to form the non-aqueous liquid electrolyte solution include lithium hexafluorophosphate (LiPF₆); lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), and combinations thereof. In certain variations, the lithium salt is selected from lithium hexafluorophosphate (LiPF₆), lithium bis(trifluoromethanesulfonimide) (LiTFSI) (LiN(CF₃SO₂)₂), lithium fluorosulfonylimide (LiN(FSO₂)₂) (LiFSI), and combinations thereof.

These and other similar lithium salts may be dissolved in a variety of organic solvents, including but not limited to various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran), 1,3-dioxolane (DOL)), sulfur compounds (e.g., sulfolane), and combinations thereof. In various aspects, the electrolyte 100 may include greater than or equal to 1M to less than or equal to about 2M concentration of the one or more lithium salts. In certain variations, for example when the electrolyte has a lithium concentration greater than about 2 M or ionic liquids, the electrolyte 100 may include one or more diluters, such as fluoroethylene carbonate (FEC) and/or hydrofluoroether (HFE).

In various aspects, the electrolyte 100 may be a solid-state electrolyte including one or more solid-state electrolyte particles that may comprise one or more polymer-based particles, oxide-based particles, sulfide-based particles, halide-based particles, borate-based particles, nitride-based particles, and hydride-based particles. Such a solid-state electrolyte may be disposed in a plurality of layers so as to define a three-dimensional structure. In various aspects, the polymer-based particles may be intermingled with a lithium salt so as to act as a solid solvent.

In certain variations, the polymer-based particles may comprise one or more of polymer materials selected from the group consisting of: polyethylene glycol, poly(p-phenylene oxide) (PPO), poly(methyl methacrylate) (PMMA), polyacrylonitrile (PAN), polyvinylidene fluoride (PVDF), poly(vinylidene fluoride-co-hexafluoropropylene (PVDF-HFP), polyvinyl chloride (PVC), and combinations thereof. In one variation, the one or more polymer materials may have an ionic conductivity equal to about 10⁻⁴ S/cm.

In various aspects, the oxide-based particles may comprise one or more garnet ceramics, LISICON-type oxides, NASICON-type oxides, and Perovskite type ceramics. For example, the one or more garnet ceramics may be selected from the group consisting of: Li_{6.5}La₃Zr_{1.75}Te_{0.25}O₁₂, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, and combinations thereof. The one or more LISICON-type oxides may be selected from the group consisting of: Li₁₄Zn(GeO₄)₄, Li₃₊ₓ(P₁₋ₓSiₓ)O₄ (where 0≤x≤1), Li₃₊ₓGeₓV₁₋ₓO₄ (where 0≤x≤1), and combinations thereof. The one or more NASICON-type oxides may be defined by LiMM′(PO₄)₃, where M and M′ are independently selected from Al, Ge, Ti, Sn, Hf, Zr, and La. For example, in certain variations, the one or more NASICON-type oxides may be selected from the group consisting of: Li₁₊ₓAlₓGe₂₋ₓ(PO₄)₃ (LAGP) (where 0≤x≤2), Li₁₊ₓAlₓTi₂₋ₓ(PO₄)₃ (LATP) (where 0≤x≤2), Li₁₋ₓYₓZr₂₋ₓ(PO₄)₃ (LYZP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The one or more Perovskite-type ceramics may be selected from the group consisting of: Li_{3.3}La_{0.53}TiO₃, LiSr_{1.65}Zr_{1.3}Ta_{1.7}O₉, Li_{2-x-y}Sr₁₋ₓTa_{y}Zr_{1-y}O₃ (where x=0.75y and 0.60≤y≤0.75), Li_{3/8}Sr_{7/16}Nb_{3/4}Zr_{1/4}O₃, Li₃ₓLa_{(2/3-x)}TiO₃ (where 0<x<0.25), and combinations thereof. In one variation, the one or more oxide-based materials may have an ionic conductivity greater than or equal to about 10⁻⁵ S/cm to less than or equal to about 10⁻³ S/cm.

In various aspects, the sulfide-based particles may include one or more sulfide-based materials selected from the group consisting of: Li₂S—P₂S₅, Li₂S—P₂S₅-MSₓ (where M is Si, Ge, and Sn and 0≤x≤2), Li_{3.4}Si_{0.4}P_{0.6}S₄, Li₁₀GeP₂S_{11.7}O_{0.3}, Li_{9.6}P₃S₁₂, Li₉P₃S₉O₃, Li_{10.35}Si_{1.35}P_{1.65}S₁₂, Li_{9.8} Sn_{0.81}P_{2.19}S₁₂, Li₁₀(Si_{0.5}Ge_{0.5})P₂S₁₂, Li(Ge_{0.5}Sn_{0.5})P₂S₁₂, Li(Si_{0.5}Sn_{0.5})PₛS₁₂, Li₁₀GeP₂S₁₂ (LGPS), Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}Sn_{1.7}Cl_{0.3}, (1−x)P₂S₅-xLi₂S (where 0.5≤x≤0.7), and combinations thereof. In one variation, the one or more sulfide-based materials may have an ionic conductivity greater than or equal to about 10⁻⁷ S/cm to less than or equal to about 10⁻² S/cm.

In various aspects, the halide-based particles may include one or more halide-based materials selected from the group consisting of: Li₂CdCl₄, Li₂MgCl₄, Li₂CdI₄, Li₂ZnI₄, Li₃OCl, LiI, Li₅ZnI₄, Li₃OCl₁₋ₓBrₓ (where 0≤x≤1), and combinations thereof. In one variation, the one or more halide-based materials may have an ionic conductivity greater than or equal to about 10⁻⁸ S/cm to less than or equal to about 10⁻⁵ S/cm.

In various aspects, the borate-based particles may include one or more borate-based materials selected from the group consisting of: Li₂B₄O₇, Li₂O—(B₂O₃)—(P₂O₅), and combinations thereof. In one variation, the one or more borate-based materials may have an ionic conductivity greater than or equal to about 10⁻⁷ S/cm to less than or equal to about 10⁻⁶ S/cm.

In various aspects, the nitride-based particles may include one or more nitride-based materials selected from the group consisting of: Li₃N, Li₇PN₄, LiSi₂N₃, LiPON, and combinations thereof. In one variation, the one or more nitride-based materials may have an ionic conductivity greater than or equal to about 10⁻⁹ S/cm to less than or equal to about 10⁻³ S/cm.

In various aspects, the hydride-based particles may include one or more hydride-based materials selected from the group consisting of: Li₃AlH₆, LiBH₄, LiBH₄—LiX (where X is one of Cl, Br, and I), LiNH₂, Li₂NH, LiBH₄—LiNH₂, and combinations thereof. In one variation, the one or more hydride-based materials may have an ionic conductivity greater than or equal to about 10⁻⁷ S/cm to less than or equal to about 10⁻⁴ S/cm.

In still further variations, the electrolyte 100 may be a quasi-solid electrolyte comprising a hybrid of the above detailed non-aqueous liquid electrolyte solution and solid-state electrolyte systems—for example including one or more ionic liquids and one or more metal oxide particles, such as aluminum oxide (Al₂O₃) and/or silicon dioxide (SiO₂).

When the electrolyte 100 is a liquid, the porous separator 80 may include, in instances, a microporous polymeric separator including a polyolefin (including those made from a homopolymer (derived from a single monomer constituent) or a heteropolymer (derived from more than one monomer constituent)), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2320 (a trilayer polypropylene/polyethylene/polypropylene separator) available from Celgard LLC.

When the porous separator 80 is a microporous polymeric separator, it may be a single layer or a multi-layer laminate. For example, in one embodiment, a single layer of the polyolefin may form the entire microporous polymer separator 80. In other aspects, the separator 80 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 80. The microporous polymer separator 80 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, and/or combinations thereof.

Furthermore, the porous separator 80 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 80 are contemplated.

With renewed reference to FIG. 3, in various aspects, the first positive electrode 40 may include a first positive current collector 42 and one or more first positive electroactive material layers 44. The one or more first positive electroactive material layers 44 may be disposed in electrical communication with the first positive current collector 42. For example, the first positive electroactive material layer 44 may be disposed at or on one or more parallel surfaces of the first positive current collector 42.

In various aspects, the second positive electrode 50 may include a second positive current collector 52 and one or more second positive electroactive material layers 54. The one or more second positive electroactive material layers 54 may be disposed in electrical communication with the second positive current collector 52. For example, the second positive electroactive material layer 54 may be disposed at or on one or more parallel surfaces of the second positive current collector 52. As illustrated, a second positive electroactive material layer 54 may be disposed on each opposing side of the second positive current collector 52 to form a bilayer structure.

The one or more first positive electroactive material layers 44 and the one or more second positive electroactive material layers 54 may each comprise a lithium-based positive electroactive material that is capable of undergoing lithium intercalation and deintercalation, absorption and desorption, alloying and dealloying, or plating and stripping, while functioning as a positive terminal of the capacitor-assisted battery 30. In various aspects, the one or more first positive electroactive material layers 44 may comprise the same or different lithium-based positive electroactive material as the one or more second positive electroactive material layers 54.

In certain variations, the one or more first positive electroactive material layer 44 may comprise a high energy capacity electroactive material. The one or more second positive electroactive material layer 54 may comprise a high power capacity electroactive material. As will be discussed further below, each electroactive layer may also include a polymeric binder and optionally a plurality of electrically conductive particles.

A high energy capacity electroactive positive material may have a specific capacity of greater than or equal to about 90 mAh/g, optionally greater than or equal to about 120 mAh/g, optionally greater than or equal to about 140 mAh/g, optionally greater than or equal to about 160 mAh/g, optionally greater than or equal to about 180 mAh/g, optionally greater than or equal to about 200 mAh/g, optionally greater than or equal to about 220 mAh/g, and in certain variations, optionally greater than or equal to about 250 mAh/g.

A high power capacity electroactive positive material may have a potential versus Li/Li+ of greater than or equal to about 1 V during lithium ion insertion and/or absorption, optionally a potential versus Li/Li+ of greater than or equal to about 1.5 V during lithium ion insertion and/or absorption.

For example, each of the one or more first positive electroactive material layers 44 and the one or more second positive electroactive material layers 44 may be defined by a plurality of positive electroactive particles (not shown) comprising one or more transition metal cations, such as manganese (Mn), nickel (Ni), cobalt (Co), chromium (Cr), iron (Fe), vanadium (V), and combinations thereof. Independent pluralities of such positive electroactive particles may be disposed in layers to define the three-dimensional structures of the one or more first positive electroactive material layers 44 and the one or more second positive electroactive material layers 54. In certain variations, the one or more first positive electroactive material layers 44 and the one or more second positive electroactive material layers 54 may further include electrolyte 100, for example a plurality of electrolyte particles (not shown). The one or more first positive electroactive material layers 44 and/or the one or more second positive electroactive material layers 54 may each have a thickness greater than or equal to about 1 μm to less than or equal to about 1,000 μm.

In various aspects, the one or more first positive electroactive material layers 44 and the one or more second positive electroactive material layers 54 may each be one of a layered-oxide cathode, a spinel cathode, and a polyanion cathode. For example, layered-oxide cathodes (e.g., rock salt layered oxides) comprises one or more lithium-based positive electroactive materials selected from LiCoO₂ (LCO), LiNiₓMn_{y}Co_{1-x-y}O₂ (where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), and Li₁₊ₓMO₂ (where M is one of Mn, Ni, Co, and Al and 0≤x≤1). Spinel cathodes comprise one or more lithium-based positive electroactive materials selected from LiMn₂O₄ (LMO) and LiNiₓMn_{1.5}O₄. Olivine type cathodes comprise one or more lithium-based positive electroactive material LiMPO₄ (where M is at least one of Fe, Ni, Co, and Mn). Polyanion cations include, for example, a phosphate such as LiV₂(PO₄)₃ and/or a silicate such as LiFeSiO₄. In this fashion, the one or more first positive electroactive material layers 34 and the one or more second positive electroactive material layers 54 may each (independently) include one or more lithium-based positive electroactive materials selected from the group consisting of: LiCoO₂ (LCO), LiNiₓMn_{y}Co_{1-x-y}O₂(where 0≤x≤1 and 0≤y≤1), LiNi_{1-x-y}CoₓAl_{y}O₂ (where 0≤x≤1 and 0≤y≤1), LiNiₓMn₁₋ₓO₂ (where 0≤x≤1), Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), and combinations thereof.

As noted above, in certain variations, a high-power capacity electroactive material may be in one of the positive electrodes 40, 50. For example, one or more second positive electroactive material layers 54 in the second positive electrode 50 may comprise an active material, such as porous carbon materials that include activated carbons (AC), carbon xerogels, carbon nanotubes (CNTs), mesoporous carbons, templated carbons, carbide-derived carbons (CDCs), graphene, porous carbon spheres, and heteroatom-doped carbon materials. Faradaic capacitor materials may also be included, such as noble metal oxides, e.g., RuO₂, transition metal oxides or hydroxides, such as MnO₂, NiO, Co₃O₄, Co(OH)₂, Ni(OH)₂, and the like. Capacitance delivered by Faradaic capacitor materials is called pseudo-capacitance, which are intrinsically fast and reversible redox reactions. Other capacitor active materials may include conducting polymers, such as polyaniline (PANI), polythiophene (PTh), polyacetylene, polypyrrole (PPy), and the like. In yet other aspects, the high-power capacity electroactive material may be a lithium titanate compound selected from the group consisting of: Li₄₊ₓTi₅O₁₂, where 0≤x≤3, including lithium titanate (Li₄Ti₅O₁₂) (LTO), Li₄₋ₓ_{^{a}}_{/3}Ti₅₋₂ₓ_{^{a}}_{/3}Crₓ_{^{a}}O₁₂, where 0≤x^{a}≤1, Li₄Ti₅₋ₓ_{^{b}}Scₓ^{b}O₁₂, where 0≤x^{b}≤1, Li₄₋ₓ_{^{c}}Znₓ_{^{c}}Ti₅O₁₂, where 0≤x^{c}≤1, Li₄TiNb₂O₇, and combinations thereof.

In certain variations, the high-power capacity electroactive material may be in one of the positive electrodes (for example, the second electrode 50) and comprise an electroactive material selected from the group consisting of: activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, such as RuO₂, transition metals, hydroxides of transition metals, MnO₂, NiO, Co₃O₄, Co(OH)₂, Ni(OH)₂, polyaniline (PANI), polythiophene (PTh), polyacetylene, polypyrrole (PPy), and the like.

In various aspects, the one or more lithium-based positive electroactive materials may be optionally coated (for example by LiNbO₃ and/or Al₂O₃) and/or may be doped (for example by magnesium (Mg)). Further, in certain variations, the one or more lithium-based positive electroactive materials may be optionally intermingled with—the one or more first positive electroactive material layers 44 and the one or more second positive electroactive material layers 54 may optionally include—one or more electrically conductive materials that provide an electron conductive path and/or at least one polymeric binder material that improves the structural integrity of the respective positive electrode 40, 50. For example, the one or more first positive electroactive material layers 44 and/or the one or more second positive electroactive material layers 54 may include greater than or equal to about 30 wt. % to less than or equal to about 98 wt. % of the one or more lithium-based positive electroactive materials; greater than or equal to about 0 wt. % to less than or equal to about 30 wt. % of electrically conductive materials; and greater than or equal to about 0 wt. % to less than or equal to about 20 wt. %, and in certain aspects, optionally greater than or equal to about 1 wt. % to less than or equal to about 20 wt. %, of a binder.

The one or more first positive electroactive material layers 44 and/or the one or more second positive electroactive material layers 54 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

The first and second positive current collectors 42, 52 may facilitate the flow of electrons between the positive electrodes 40, 50 and an exterior circuit. For example, an interruptible external circuit 120 and a load device 130 may connect the first positive electrode 40 (through the first positive current collector 42) and the second positive electrode 50 (through the second positive current collector 52). The positive current collectors 42, 52 may include metal, such as a metal foil, a metal grid or screen, or expanded metal. For example, the positive current collectors 42, 52 may be formed from aluminum, stainless steel and/or nickel or any other appropriate electrically conductive materials known to those of skill in the art. In various aspects, the first and second positive current collectors 42, 52 may be the same or different.

In various aspects, the negative electrode 60 may include a first negative current collector 62 and one or more first negative electroactive material layers 64. The one or more first negative electroactive material layers 64 may be disposed in electrical communication with the first negative current collector 62. For example, the one or more first negative electroactive material layers 64 may be disposed at or near one or more parallel surfaces of the first negative current collector 62. As illustrated, a first negative electroactive material layer 64 may be disposed both at or on the first negative current collector 62, for example, to define a bilayer structure.

Like the positive current collectors 42, 52, the first negative current collector 62 may include metal, such as a metal foil, a metal grid or screen, or expanded metal. For example, the first negative current collector 62 may be formed from copper, aluminum or any other appropriate electrically conductive material known to those of skill in the art. The one or more first negative electroactive material layers 64 may comprise a lithium host material (e.g., negative electroactive material) that is capable for functioning as a negative terminal of the capacitor-assisted battery 30. The one or more first negative electroactive material layers 64 may be defined by a plurality of negative electroactive particles (not shown) that are lithium based. For example, the electroactive material may include a lithium metal and/or lithium alloy; silicon based, comprising, for example, a silicon or silicon alloy or silicon oxide. The electroactive material may also include graphite; carbonaceous material, comprising, for example, one or more of activated carbon (AC), activated carbon (AC), hard carbon (HC), soft carbon (SC), graphite, graphene, and carbon nanotubes (“CNTs”); and/or comprising one or more lithium-accepting anode materials such as lithium titanium oxide (Li₄Ti₅O₁₂), one or more transition metals (such as tin (Sn)), one or more metal oxides (such as vanadium oxide (V₂O₅), titanium dioxide (TiO₂)), titanium niobium oxide (TiₓNb_{y}O_{z}, where 0≤x≤2, 0≤y≤24, and 0≤z≤64), and one or more metal sulfides (such as ferrous sulfide (FeS)).

The one or more first negative electroactive material layers 64 may each include a negative electroactive material selected from the group consisting of: lithium metal, lithium alloy, silicon (Si), silicon alloy, silicon oxide, activated carbon (AC), hard carbon (HC), soft carbon (SC), graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z}, where 0≤x≤2, 0≤y≤24, and 0≤z≤64), ferrous sulfide (FeS), and combinations thereof. The one or more first negative electroactive material layers 64 may each have a thickness greater than or equal to about 1 μm to less than or equal to about 1,000 μm.

In certain variations, the one or more first negative electroactive material layers 64 may comprise a high-energy capacity electroactive material. As will be described below, the one or more second negative electroactive material layers 74 in the second negative electrode 70 may comprise a high power capacity electroactive material. The high-energy capacity negative electroactive material may be selected from the group consisting of: carbon-containing materials, silicon, silicon-containing alloys, tin-containing alloys, and combinations thereof. In certain variations, the high-energy capacity electroactive material comprises a carbon-containing compound, such as disordered carbons and graphitic carbons/graphite.

In certain variations, the high-power capacity electroactive material may be in one of the negative electrodes 60, 70 and comprise an active material, such as porous carbon materials that include activated carbons (AC), carbon xerogels, carbon nanotubes (CNTs), mesoporous carbons, templated carbons, carbide-derived carbons (CDCs), graphene, porous carbon spheres, and heteroatom-doped carbon materials. Faradaic capacitor materials may also be included, such as noble metal oxides, e.g., RuO₂, transition metal oxides or hydroxides, such as MnO₂, NiO, Co₃O₄, Co(OH)₂, Ni(OH)₂, and the like. Capacitance delivered by Faradaic capacitor materials is called pseudo-capacitance, which are intrinsically fast and reversible redox reactions. Other capacitor active materials may include conducting polymers, such as polyaniline (PANI), polythiophene (PTh), polyacetylene, polypyrrole (PPy), and the like. In yet other aspects, the high-power capacity electroactive material may be a lithium titanate compound selected from the group consisting of: Li₄₊ₓTi₅O₁₂, where 0≤x≤3, including lithium titanate (Li₄Ti₅O₁₂) (LTO), Li₄₋ₓ_{^{a}}_{/3}Ti₅₋₂ₓ_{^{a}}_{/3}Crₓ_{^{a}}O₁₂, where 0≤x^{a}≤1, Li₄Ti₅₋ₓ_{^{b}}Scₓ_{^{b}}O₁₂, where 0≤x^{b}≤1, Li₄₋ₓ_{^{c}}Znₓ_{^{c}}Ti₅O₁₂, where 0≤x^{c}≤1, Li₄TiNb₂O₇, and combinations thereof.

In certain variations, the high-power capacity electroactive material may be in one of the negative electrodes 60, 70 and comprise an electroactive material selected from the group consisting of: activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, such as RuO₂, transition metals, hydroxides of transition metals, MnO₂, NiO, Co₃O₄, Co(OH)₂, Ni(OH)₂, polyaniline (PANI), polythiophene (PTh), polyacetylene, polypyrrole (PPy), and the like.

In certain other aspects, the negative electrode may comprise a negative electroactive material selected from the group consisting of: lithium metal, lithium alloy, silicon (Si), silicon alloy, silicon oxide, activated carbon, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

In various aspects, the one or more negative electroactive materials may be optionally intermingled with one or more electrically conductive materials that provide an electron conductive path and/or at least one polymeric binder material that improves the structural integrity of the one or more electroactive material layers 64 in the negative electrode 60. For example, the one or more first negative electroactive material layers 64 may include greater than or equal to about 0 wt. % to less than or equal to about 99 wt. % of the negative electroactive material; greater than or equal to about 0 wt. % to less than or equal to about 30 wt. % of electrically conductive materials; and greater than or equal to about 0 wt. % to less than or equal to about 20 wt. %, and in certain aspects, optionally greater than or equal to about 1 wt. % to less than or equal to about 20 wt. % of a binder.

The one or more first negative electroactive material layers 64 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

In various aspects, the fourth negative electrode 70 may include a second negative current collector 72 and one or more second negative electroactive material layers 74. The one or more second negative electroactive material layers 74 may disposed in electrical communication with the second negative current collector 72. For example, the one or more second negative electroactive material layers 74 may be disposed at or on one or more parallel surfaces of the second negative current collector 72. The one or more second negative electroactive material layers 74 may comprise an electroactive material like those discussed in the context of the first negative electrode 60.

Like the first negative current collector 72, the second negative current collector 72 may include metal, such as a metal foil, a metal grid or screen, or expanded metal. For example, the second negative current collector 72 may be formed from copper, aluminum or any other appropriate electrically conductive material known to those of skill in the art. The second negative current collector 72 may be same or different from the first negative current collector 62. The first and second negative current collectors 62, 72 may facilitate the flow of electrons between the negative electrodes 60, 70 and the exterior circuit 120. For example, the interruptible external circuit 120 and the load device 130 may connect the first negative electrode 60 (through the first negative current collector 62) and the second negative electrode 70 (through the second positive current collector 72) either in series or parallel.

In certain variations, the first positive electrode may comprise a high energy capacity positive electroactive material. The second positive electrode may comprise a high power capacity electroactive material. The third negative electrode and the fourth negative electrode may comprise the same negative electroactive material. The first positive electrode and the third negative electrode define a lithium-ion battery. The second positive electrode and the fourth negative electrode define a capacitor.

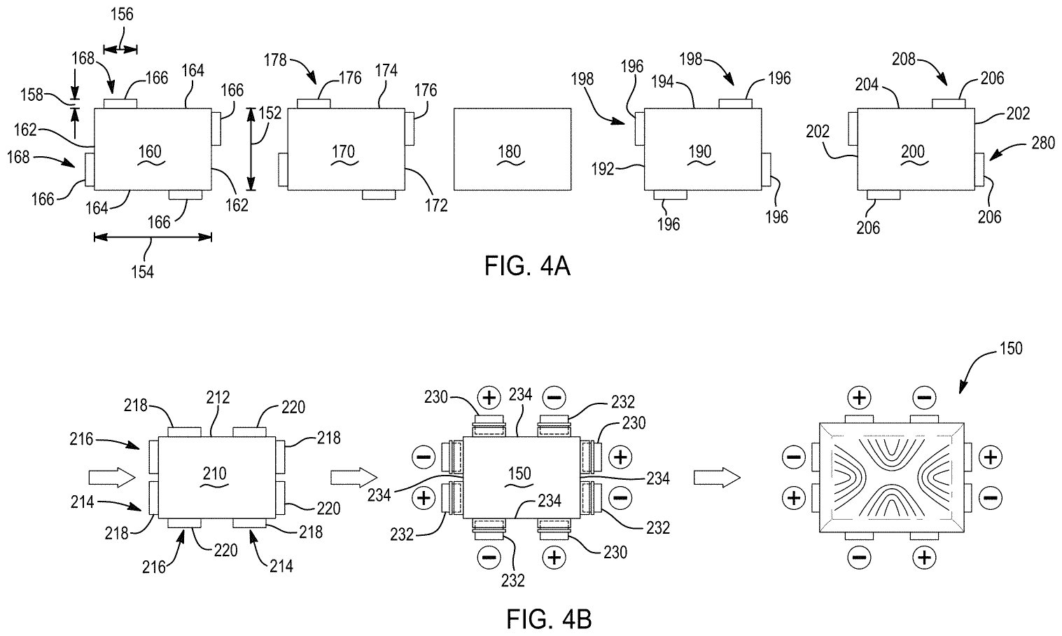

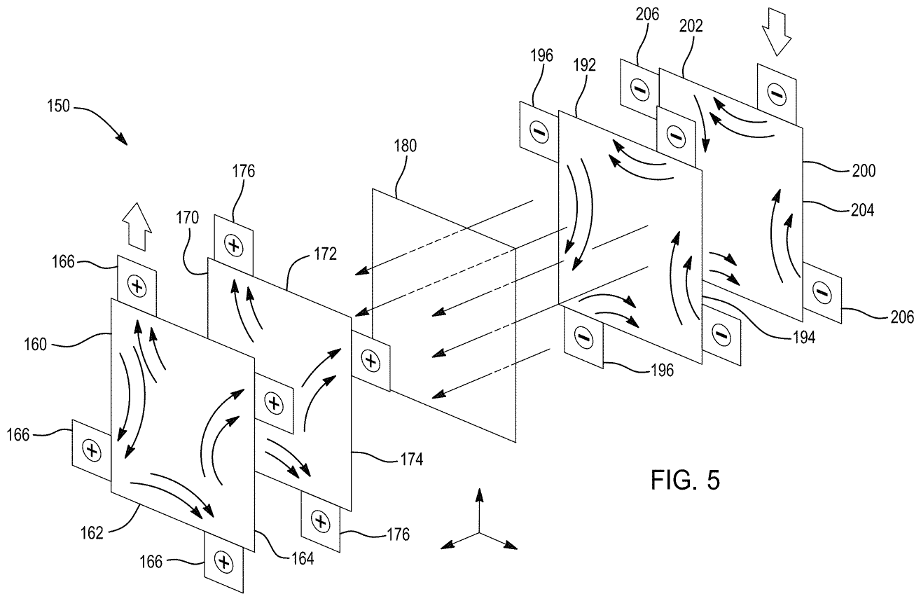

FIGS. 4A-4B and 5 show components that form a capacitor-assisted hybrid lithium-ion electrochemical cell assembly 150 prepared in accordance with certain aspects of the present disclosure having electrode components to reduce current density during high power charging and discharging with tabs on four distinct edges. A first positive electrode 160 has a first polarity and defines four lateral edges, including two edges 162 having a first dimension 152 (e.g., length). The two edges 162 are parallel and opposite to one another across the first positive electrode 160. There are also two edges 164 having a second dimension 154 (e.g., length) greater than the first dimension, which are also parallel, but opposite to one another across the first positive electrode 160. In this manner, the first positive electrode 160 defines a generally rectangular shape. It should be noted that in alternative variations, the rectangular shape may in fact be a square where the first length of two edges 162 and second length of two edges 164 may be the same. This is true for any of the rectangular shapes discussed herein.

The first positive electrode 160 has two first electrically conductive tabs 166 disposed on at least one edge 162 having the first length and at least one edge 164 having the second length. As shown in FIG. 4B, the first electrically conductive tabs 166 are disposed on all four edges, so that the first positive electrode 160 has four first electrically conductive tabs 166. Each tab 166 is positioned at a location on a first side 168 of the respective edges 162, 164. Each tab 166 has a width 156 and a height 158. Each tab has a width 156 that occupies less than half of the length of each edge, for example, a tab width 156 may be greater than or equal to about 20% to less than or equal to about 45% of an overall length of each respective edge. In certain aspects, a height 158 of the tab 166 may be greater than or equal to about 5 mm to less than or equal to about 30 mm. In certain other aspects, a width 156 of the tab 166 may be greater than or equal to about 30 mm to less than or equal to about 300 mm. While each of the tabs 166 may have the same dimensions and rectangular shape, they may also be varied in dimensions and shape from edge to edge.

The first positive electrode 160 comprises a current collector having an electroactive layer disposed thereon. In certain variations, the current collector defines the plurality of electrically conductive tabs 166. Thus, the electrically conductive tabs 166 may be formed from the same material as a current collector, for example, a metal foil.

Also shown is a second positive electrode 170 having the same first polarity as the first positive electrode 160. In certain variations, the second positive electrode 170 may comprise a distinct active material from the first positive electrode 160. The second positive electrode 170 defines four lateral edges, including two edges 172 having a first dimension (e.g., length). The two edges 172 are parallel and opposite to one another across the second positive electrode 170. There are also two edges 174 having a second dimension (e.g., length) greater than the first dimension, which are also parallel, but opposite to one another across the second positive electrode 170. In this manner, the second positive electrode 170 defines a generally rectangular shape.

The second positive electrode 170 has least two first electrically conductive tabs 176 disposed on at least one edge 172 having the first length and at least one edge 174 having the second length. As shown in FIG. 4B, the first electrically conductive tabs 176 are disposed on all four edges, so that the second positive electrode 170 has four second electrically conductive tabs 176. Each tab 176 is positioned at a location on a first side 178 of the respective edges 162, 164. The first side 168 of the first positive electrode 160 corresponds to the first side 178 of the second positive electrode 170, so that the tabs 166, 176 may be aligned, superimposed, and connected together. Each tab 176 may have the same properties and dimensions as tabs 166 described in the context of the first positive electrode 160.

The second positive electrode 170 also comprises a current collector having an electroactive layer disposed thereon. In certain variations, the current collector further defines the plurality of second electrically conductive tabs 176. Thus, the second electrically conductive tabs 176 may be formed from the same material as a current collector, for example, a metal foil.

The next component in the capacitor-assisted hybrid lithium-ion electrochemical cell assembly 150 is a separator 180 that provides an electrical barrier between the first and second positive electrodes 160, 170 and the negative electrodes to be described herein.

Third negative electrode 190 has a second polarity opposite to the first polarity. The electrode 190 defines four lateral edges, including two edges 192 having a first dimension (e.g., length). The two edges 192 are parallel and opposite to one another across the electrode 190. There are also two edges 164 having a second dimension (e.g., length) greater than the first dimension, which are also parallel, but opposite to one another across the electrode 190. In this manner, the electrode 190 defines a generally rectangular shape. The electrode 190 has least two first electrically conductive tabs 196 disposed on at least one edge 192 having the first length and at least one edge 194 having the second length. The third electrically conductive tabs 196 are disposed on all four edges, so that the electrode 190 has four third electrically conductive tabs 196. Each tab 196 is positioned at a location on a second side 198 of the respective edges 192, 194. Notably, the second side 198 is opposite to the first sides 168, 178 along the edges of the first positive electrodes 160, 170 when they are superimposed onto one another. Each tab 196 occupies less than half of an overall length of each edge, for example, a tab width may be greater than or equal to about 20% to less than or equal to about 45% of an overall length of each respective edge. In certain aspects, a height of the tab 196 may be greater than or equal to about 5 mm to less than or equal to about 30 mm. In certain other aspects, a width of the tab 196 may be greater than or equal to about 30 mm to less than or equal to about 300 mm. While each of the tabs 196 may have the same dimensions and rectangular shape, they may also be varied in dimensions and shape from edge to edge.

The third negative electrode 190 comprises a current collector having an electroactive layer disposed thereon. In certain variations, the current collector defines the third plurality of electrically conductive tabs 196. Thus, the third electrically conductive tabs 196 may be formed from the same material as a current collector, for example, a metal foil.

A fourth negative electrode 200 has the same second polarity as the third negative electrode 190. In certain variations, the fourth negative electrode 200 may comprise a distinct active material from the third negative electrode 190. In other variations, the third and fourth negative electrodes 190, 200 may comprise the same active material. The fourth negative electrode 200 defines four lateral edges, including two edges 202 having a first dimension (e.g., length). The two edges 202 are parallel and opposite to one another across the electrode 200. There are also two edges 204 having a second dimension (e.g., length) greater than the first dimension, which are also parallel, but opposite to one another across the electrode 200. In this manner, the electrode 200 defines a generally rectangular shape.

The fourth negative electrode 200 has at least two fourth electrically conductive tabs 206 disposed on at least one edge 192 having the first length and at least one edge 194 having the second length. The fourth electrically conductive tabs 206 are disposed on all four edges, so that the electrode 200 has four first electrically conductive tabs 206. Each tab 206 is positioned at a location on a first side 208 of the respective edges 202, 204. The second side 198 of the third negative electrode 190 corresponds to the first side 208 of the electrode 200, so that they may be aligned, superimposed, and connected together. Each fourth tab 206 may have the same properties and dimensions as tabs 196 described in the context of the third negative electrode 190 or first positive tab 166.

The fourth negative electrode 200 also comprises a current collector having an electroactive layer disposed thereon. In certain variations, the current collector defines the fourth plurality of electrically conductive tabs 206. Thus, the electrically conductive tabs 206 may be formed from the same material as a current collector, for example, a metal foil.

The first positive electrode 160, the second positive electrode 170, the separator 180, the third negative electrode 190, and the fourth negative electrode 200 are then stacked together to form a core cell assembly 210. As will be appreciated by those of skill in the art, while not shown in 4A-4B and 5, the order and arrangement of components may differ from those shown. For example, in one variation, a core cell assembly may include the first positive electrode 160, separator 180, third negative electrode 190, another separator 180, the second positive electrode 170, separator 180 and fourth negative electrode 200 stacked together to form a core cell assembly. In the core cell assembly 210, each edge 212 defines a first side 214 and a second side 216. Notably, the sides are defined with respect to each edge and change orientation for opposite parallel sides. The first side 214 corresponds to the first side 168 of first positive electrode 160 and first side 178 of the second positive electrode 170. As noted above, the plurality of the first electrically conductive tabs 166 of the first positive electrode 160 substantially align with the plurality of second electrically conductive tabs 176 of the second positive electrode 170 on the first side 214 when they are assembled in a stack and thus form common positive tabs 218. By substantially align, it is meant that the tabs generally have the same dimensions and thus align with one another when stacked, but there may be some small deviation in tolerances or alignment as a result of typical manufacturing processes. Likewise, the plurality of third electrically conductive tabs 196 of the third negative electrode 190 substantially align with the plurality of fourth electrically conductive tabs 206 of the fourth negative electrode 200 on the second side 216 when they are assembled in a stack and thus form common negative tabs 220.

The core cell assembly 210 is incorporated into and forms the capacitor-assisted hybrid lithium-ion electrochemical cell assembly 150. The common positive tabs 218 may be welded together and appropriately capped or sheathed to form a plurality of positive electrical connectors 230. The positive electrical connectors 230 may be connected to other electrical conduits with the same polarity, such as bus bars, circuitry, or may themselves form terminals for external connection to a load and power source. For example, certain examples of formation of the electrical connectors may include using a one-step ultrasonic welding to weld the electrode tab foil with external terminals (e.g., outside tabs for forming the final cell). Alternatively, ultrasonic welding can be first used to weld the electrode tab foil, and then use ultrasonic welding to weld foil with external terminals. In another example, ultrasonic welding can be used to weld the electrode tab foil first, and then laser and/or resistance welding can be used to weld foil with external terminals. In certain aspects, an external terminal material for a positive electrode comprises aluminum, by way of example.

Similarly, the common negative tabs 220 may be welded together and appropriately capped or sheathed to form a plurality of negative electrical connectors 232. The negative electrical connectors 232 may be connected to other electrical conduits with the same polarity, such as bus bars, circuitry, or may themselves form terminals for external connection to loads, generators, or power sources and the like in the same manner as described above in the context of the positive electrical connector 230. In certain aspects, an external terminal material for a negative electrode comprises aluminum, copper, nickel, and nickel-coated copper, by way of example. The capacitor-assisted hybrid lithium-ion electrochemical cell assembly 150 can be incorporated into other components, such as a housing or pouch.

Each edge 234 of the capacitor-assisted hybrid lithium-ion electrochemical cell assembly 150 has both a positive electrical connector and a spaced apart negative electrical connector. The plurality of positive and negative electrical connectors on each edge of the electrochemical cell serves to distribute current more uniformly during operation and lithium ion cycling, thus minimizing variations in current and minimizing current density within the high powered cell, as shown in FIG. 4B. More specifically, by including eight tabs, where two tabs are connected to positive or negative electrical connectors on each lateral edge, this design reduces the current and current density carried by any one of the tabs connected to positive or negative electrical connectors, which is particularly advantageous for ultra-high power applications. This in turns serves to reduce hot spots and diminish thermal gradients during high power charge and discharge conditions. By way of example, where performance of a capacitor-assisted hybrid lithium-ion electrochemical cell assembly having eight tabs prepared in accordance with certain aspects of the present disclosure is compared to a conventional two tab design for a comparative capacitor-assisted hybrid lithium-ion electrochemical cell assembly with the same materials, a maximum current density is decreased by greater than or equal to about 50%, optionally greater than or equal to about 60%, optionally greater than or equal to about 70%, and in certain variations, optionally greater than or equal to about 75%. A reduction in maximum current density favorably reduces thermal gradients, which are affected by charge/discharge currents. The higher the current (or current density), the larger the thermal gradient. Thus, minimizing the current density serves to favorably reduce thermal gradients.

Generally, an electrochemical cell can refer to a unit that can be connected to other units. A plurality of electrically connected cells, for example, those that are stacked together, may be considered to be a module. A pack generally refers to a plurality of operatively-connected modules, which may be electrically connected in various combinations of series or parallel connections. The battery module may thus be encased in a pouch structure, a housing, or located with a plurality of other battery modules to form a battery pack. In certain aspects, the battery module may be part of a prismatic hybrid cell battery.

FIG. 5 shows exploded view of various components in a capacitor-assisted hybrid lithium-ion electrochemical cell assembly prepared in accordance with certain aspects of the present disclosure like that in FIGS. 4A-4B, showing current distribution within each of the electrodes 160, 170, 190, and 200 that would occur in the stacked and assembled device.

In certain aspects, either the first positive electrode 160 or third negative electrode 190 comprises a high energy capacity electroactive material and the second positive electrode 170 or the fourth negative electrode 200 comprises a high power capacity electroactive material. In this manner, the first positive electrode 160 and the third negative electrode 190 define a lithium-ion battery within the capacitor-assisted hybrid lithium-ion electrochemical cell assembly 150, while the second positive electrode 170 and the fourth negative electrode 200 define a capacitor within the capacitor-assisted hybrid lithium-ion electrochemical cell assembly 150. In certain aspects, the first positive electrode 160 comprises a high energy capacity electroactive material, the second positive electrode 170 comprises a high power capacity electroactive material, such as a capacitor material. The corresponding third and fourth negative electrodes 190, 200 may be compatible negative electroactive materials for the respective lithium-ion battery and the capacitor. As will be appreciated by those of skill in the art, the various embodiments of capacitor-assisted hybrid lithium-ion electrochemical cell assemblies described in the context of the present disclosure are not limited to a single capacitor electrode, but rather may have a plurality of capacitors stacked within the cell core assembly at any location. Thus, a capacitor hybridization ratio can be tuned by the number of capacitor electrode layers included in the assembly. The capacitor-assisted hybrid lithium-ion electrochemical cell assembly 150 may be formed by an intermittent coating process forming discrete electrodes on a current collector foil, where the tabs are notched into each respective discrete electrode in the appropriate positions along lateral edges.

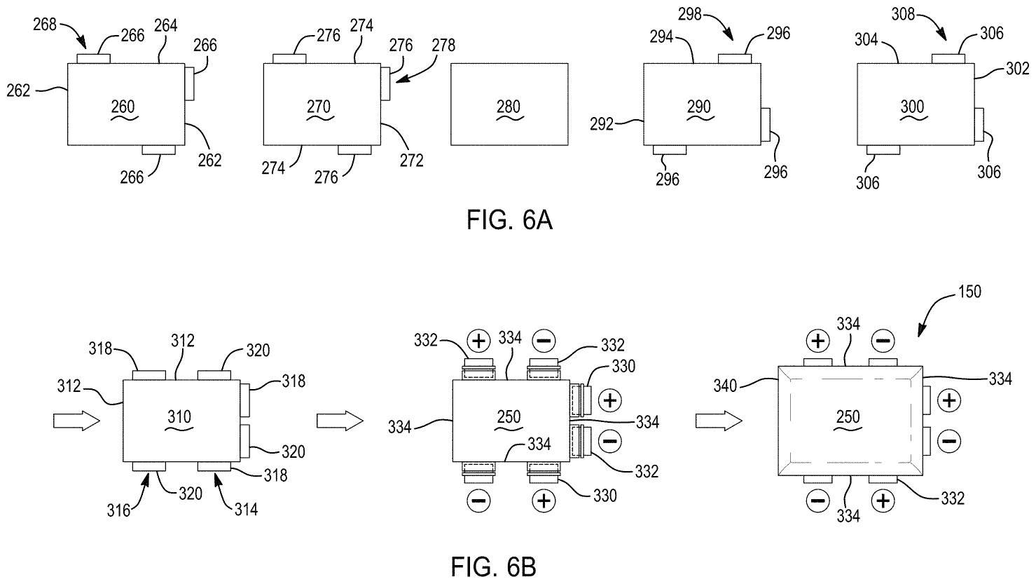

FIGS. 6A-6B show components of another variation of a capacitor-assisted hybrid lithium-ion electrochemical cell assembly 250 prepared in accordance with certain aspects of the present disclosure having electrode components with tabs on three distinct edges. For brevity, unless otherwise specifically addressed, the components of the capacitor-assisted hybrid lithium-ion electrochemical cell assembly 250 having the same design, function, and/or dimensions as those in the capacitor-assisted hybrid lithium-ion electrochemical cell assembly 150 previously described will not be described again in detail, but may share the same properties and dimensions as discussed above.

A first positive electrode 260 includes two edges 262 with a first length and two edges 264 with a second length, which may be greater than the first length. The first positive electrode 260 has three first electrically conductive tabs 266. One tab 266 is disposed on one edge 262 having the first length and two tabs 266 are disposed respectively on two edges 264 having the second length. Thus, the first electrically conductive tabs 266 are disposed on three of four lateral edges of the first positive electrode 260, so that one lateral edge is free of a tab. Each tab 266 is positioned at a location on a first side 268 of the respective edges 262, 264.

Also shown is a second positive electrode 270. In certain variations, the second positive electrode 270 may comprise a distinct active material from the first positive electrode 260. The second positive electrode 270 includes two edges 272 with a first length and two edges 274 with a second length, optionally greater than the first length. The second positive electrode 270 has three second electrically conductive tabs 276. One tab 276 is disposed on one edge 272 having the first length and two tabs 276 are disposed on two edges 274 having the second length. Thus, the first electrically conductive tabs 276 are disposed on three of four lateral edges of the second positive electrode 270, so that one lateral edge is free of any tabs. Each tab 276 is positioned at a location on a first side 278 of the respective edges 272, 274.

A separator 280 is included. A third negative electrode 290 includes two edges 292 with a first length and two edges 294 with a second length optionally greater than the first length. The third negative electrode 290 has three third electrically conductive tabs 296. One tab 296 is disposed on one edge 292 having the first length and two tabs 296 are disposed respectively on two edges 294 having the second length. Thus, the third electrically conductive tabs 296 are disposed on three of four lateral edges of the third negative electrode 290, so that one edge is free of any tabs. Each tab 296 is positioned at a location on a first side 298 of the respective edges 292, 294.

A fourth negative electrode 300 includes two edges 302 with a first length and two edges 304 with a second length optionally greater than the first length. In certain variations, the fourth negative electrode 300 may comprise a distinct active material from the third negative electrode 290. The fourth negative electrode 300 has three fourth electrically conductive tabs 306. One tab 306 is disposed on one edge 302 having the first length and two tabs 306 are disposed respectively on two edges 304 having the second length. Thus, the fourth electrically conductive tabs 306 are disposed on three of four lateral edges, so that one edge is free of and does not have any tabs. Each tab 306 is positioned at a location on a first side 308 of the respective edges 302, 304.

The first positive electrode 260, the second positive electrode 270, the separator 280, the third negative electrode 290, and the fourth negative electrode 300 are then stacked together to form a core cell assembly 310. In the core assembly 310, each edge 312 defines a position at a first side 314 and a position at a second side 316. The first side 314 corresponds to the first side 268 of first positive electrode 260 and first side 278 of the second positive electrode 270. The plurality of the first electrically conductive tabs 266 of the first positive electrode 260 substantially align with the plurality of second electrically conductive tabs 276 of the second positive electrode 270 on the first side 314 when they are assembled together (e.g., stacked) and thus form common positive tabs 318. Likewise, the plurality of third electrically conductive tabs 296 of the third negative electrode 290 substantially align with the plurality of fourth electrically conductive tabs 306 of the fourth negative electrode 300 on the second side 316 when they are assembled in a stack and thus form common negative tabs 320.

The core cell assembly 310 then is incorporated into and forms the capacitor-assisted hybrid lithium-ion electrochemical cell assembly 250. The common positive tabs 318 may be welded together and appropriately capped or sheathed to form a plurality of positive electrical connectors 330. The positive electrical connectors 330 may be connected to other electrical conduits with the same polarity, such as bus bars, circuitry, or may themselves form terminals for external connection to loads, generators, or power sources and the like. Such a process may be similar to that previously described and will not be repeated herein. Similarly, the common negative tabs 320 may be welded together and appropriately capped or sheathed to form a plurality of negative electrical connectors 332. The negative electrical connectors 332 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 150 can be incorporated into other components, such as a housing or pouch 340 prior to or after forming the positive electrical connector 330 and negative electrical connector 332.

Three of four lateral edges 334 of the capacitor-assisted hybrid lithium-ion electrochemical cell assembly 250 have both a positive electrical connector 330 and a spaced apart negative electrical connector 332 (corresponding to the first side 314 and second side 316 of each lateral edge 312). The plurality of positive and negative electrical connectors 330, 332 on three edges of the electrochemical cell serves to distribute current more uniformly during operation and lithium ion cycling, thus minimizing variations in current and minimizing current density within the high powered cell, as shown in FIG. 6B. Again, by including six tabs, where two tabs are connected to positive or negative electrical connectors on three lateral edges of the electrochemical cell assembly, this design reduces the current and current density carried by any one of the tabs connected to positive or negative electrical connectors, which is particularly advantageous for ultra-high power applications. This in turns serves to reduce hot spots and diminish thermal gradients during high power charge and discharge conditions. By way of example, where performance of a capacitor-assisted hybrid lithium-ion electrochemical cell assembly having six tabs prepared in accordance with certain aspects of the present disclosure is compared to a conventional two tab design for a comparative capacitor-assisted hybrid lithium-ion electrochemical cell assembly with the same materials, a maximum current density is decreased by greater than or equal to about 45%, optionally greater than or equal to about 50%, optionally greater than or equal to about 60%, and in certain variations, optionally greater than or equal to about 70%. A reduction in maximum current density favorably reduces thermal gradients, which are affected by charge/discharge currents. The higher the current (or current density), the larger the thermal gradient. Thus, minimizing the current density serves to favorably reduce thermal gradients.

The capacitor-assisted hybrid lithium-ion electrochemical cell assembly 250 may be formed by an intermittent coating process forming discrete electrodes on a current collector foil, where the tabs are notched into each respective discrete electrode in the appropriate positions along lateral edges.

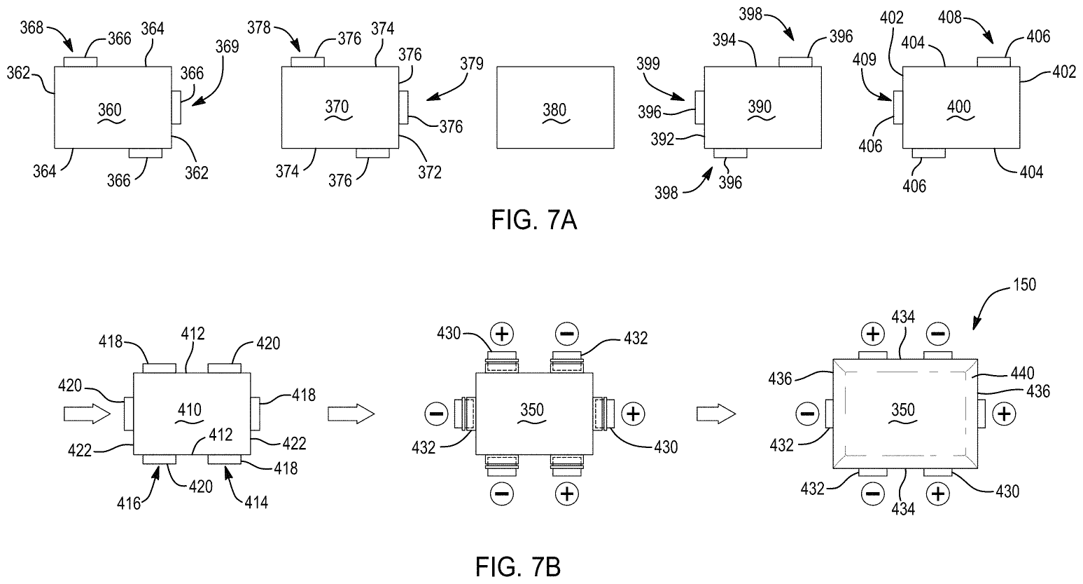

FIGS. 7A-7B show components of another variation of a capacitor-assisted hybrid lithium-ion electrochemical cell assembly 350 prepared in accordance with certain aspects of the present disclosure having electrode components with tabs on three distinct edges. For brevity, unless otherwise specifically addressed, the components of the capacitor-assisted hybrid lithium-ion electrochemical cell assembly 350 having the same design, function, and dimensions as those in the capacitor-assisted hybrid lithium-ion electrochemical cell assembly 150 in FIGS. 4A-4B previously described will not be described again in detail, but will be understood to share the same properties and dimensions as discussed above.

A first positive electrode 360 includes two edges 362 with a first length and two edges 364 with a second length, which may be greater than the first length. The first positive electrode 360 has three first electrically conductive tabs 366. One tab 366 is disposed on one edge 362 having the first length and two tabs 366 are disposed respectively on two edges 364 having the second length. Thus, the first electrically conductive tabs 366 are disposed on three of four lateral edges of the first positive electrode 360, so that one lateral edge is free of a tab. The tabs 366 on the first edge 364 are positioned at a location corresponding to a first side 368 of the respective edge 364. However, the tab 366 on the edge 362 with the first length is disposed at a location corresponding to a central region 369 of the edge 362.

Also shown is a second positive electrode 370. In certain variations, the second positive electrode 370 may comprise a distinct active material from the first positive electrode 360. A second positive electrode 370 includes two edges 372 with a first length and two edges 374 with a second length, which may be greater than the first length. The second positive electrode 370 has three first electrically conductive tabs 376. One tab 376 is disposed on one edge 372 having the first length and two tabs 376 are disposed respectively on two edges 374 having the second length. Thus, the first electrically conductive tabs 766 are disposed on three of four lateral edges of the second positive electrode 370, so that one lateral edge is free of a tab. The tabs 376 on the first edge 374 are positioned at a location corresponding to a first side 378 of the respective edge 374. However, the tab 376 on the edge 372 with the first length is disposed at a location corresponding to a central region 379 of the edge 372.

A separator 380 is included. A third negative electrode 390 includes two edges 392 with a first length and two edges 394 with a second length optionally greater than the first length. The third negative electrode 390 has three third electrically conductive tabs 396. One tab 396 is disposed on one edge 392 having the first length and two tabs 396 are disposed respectively on two edges 394 having the second length. Thus, the third electrically conductive tabs 396 are disposed on three of four lateral edges of the third negative electrode 390, so that one edge is free of any tabs. Two tabs 396 on the two edges 294 with the second length are positioned at a location on a first side 398. However, the tab 396 on the edge 392 with the first length is disposed at a location corresponding to a central region 399 of the edge 392.

A fourth negative electrode 400 may comprise a distinct active material from the third negative electrode 390. The fourth negative electrode 400 includes two edges 402 with a first length and two edges 404 with a second length optionally greater than the first length. The fourth negative electrode 400 has three fourth electrically conductive tabs 406. One tab 406 is disposed on one edge 402 having the first length and two tabs 406 are disposed respectively on two edges 404 having the second length. Thus, the fourth electrically conductive tabs 406 are disposed on three of four lateral edges, so that one edge is free of and does not have any tabs. Two tabs 406 on the two edges 404 with the second length are positioned at a location on a first side 408. However, the tab 406 on the edge 402 with the first length is disposed at a location corresponding to a central region 409 of the edge 402.

The first positive electrode 360, the second positive electrode 370, the separator 380, the third negative electrode 390, and the fourth negative electrode 400 are then stacked together to form a core cell assembly 410. In the core assembly 410, edges 412 having the second length define a position at a first side 414 and a position at a second side 416. The first side 414 corresponds to the first side 368 of first positive electrode 360 and first side 378 of the second positive electrode 370. The plurality of the first electrically conductive tabs 366 of the first positive electrode 360 substantially align with the plurality of second electrically conductive tabs 376 of the second positive electrode 370 on the first side 414 when they are assembled together (e.g., stacked) and thus form common positive tabs 418. Likewise, edges 412 having the second length includes the plurality of third electrically conductive tabs 396 of the third negative electrode 390 substantially aligned with the plurality of fourth electrically conductive tabs 406 of the fourth negative electrode 400 on the second side 416. When they are assembled (e.g., stacked) they form thus form common negative tabs 420. Further, opposite edges 422 having the first length each have either common positive tab 418 or a common negative tab 420. The common positive tab 418 on edge 422 is formed by substantially aligning the first electrically conductive tabs 366 of the first positive electrode 360 substantially align with the plurality of second electrically conductive tabs 376 of the second positive electrode 370. The common negative tab 420 on opposite edge 422 having the second length is formed by substantially aligning the plurality of third electrically conductive tabs 396 of the third negative electrode 390 with the plurality of fourth electrically conductive tabs 406 of the fourth negative electrode 400.

The core cell assembly 410 then is incorporated into and forms the capacitor-assisted hybrid lithium-ion electrochemical cell assembly 350. The common positive tabs 418 may be welded together and appropriately capped or sheathed to form a plurality of positive electrical connectors 430. The positive electrical connectors 330 may be connected to other electrical conduits with the same polarity, such as bus bars, circuitry, or may themselves form terminals for external connection to loads, generators, or power sources and the like. Similarly, the common negative tabs 420 may be welded together and appropriately capped or sheathed to form a plurality of negative electrical connectors 432. The negative electrical connectors 432 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 350 can be incorporated into other components, such as a housing or pouch 440 prior to or after forming the positive electrical connector 430 and negative electrical connector 432.

Two of four lateral edges 434 of the capacitor-assisted hybrid lithium-ion electrochemical cell assembly 350 have both a positive electrical connector 430 and a spaced apart negative electrical connector 432 (corresponding to the first side 414 and second side 416 of each lateral edge 412). Further, each of opposing lateral edges 436 has one of either a positive electrical connector 430 or a negative electrical connector 432. Thus, two edges of the electrochemical cell assembly have both a positive electrical connector and a spaced apart negative electrical connector, one edge has a single positive electrical connector, and an opposite edge has a single negative electrical connector.

The plurality of positive and negative electrical connectors 430, 432 on four edges of the electrochemical cell serves to distribute current more uniformly during operation and lithium ion cycling, thus minimizing variations in current and minimizing current density within the high powered cell. By including six tabs integrally formed with and connected to positive or negative electrical connectors on four lateral edges of the electrochemical cell assembly, current and current density carried by any one of the tabs are minimized, which is particularly advantageous for ultra-high power applications. This in turns serves to reduce hot spots and diminish thermal gradients during high power charge and discharge conditions, as previously discussed.

The capacitor-assisted hybrid lithium-ion electrochemical cell assembly 350 may be formed by an intermittent coating process forming discrete electrodes on a current collector foil, where the tabs are notched into each respective discrete electrode in the appropriate positions along lateral edges.

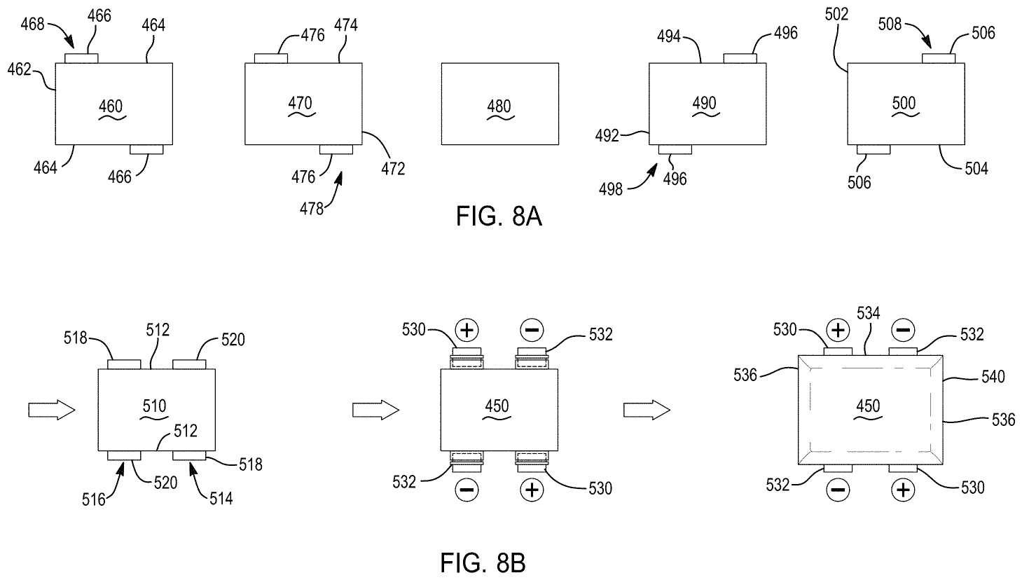

FIGS. 8A-8B show components of another variation of a capacitor-assisted hybrid lithium-ion electrochemical cell assembly 450 prepared in accordance with certain aspects of the present disclosure having electrode components with tabs on two distinct parallel lateral edges. For brevity, unless otherwise specifically addressed, the components of the capacitor-assisted hybrid lithium-ion electrochemical cell assembly 450 having the same design, function, and/or dimensions as those in the capacitor-assisted hybrid lithium-ion electrochemical cell assembly 150 in FIGS. 4A-4B previously described will not be described again in detail, but will be understood to share the same properties and dimensions as discussed above.

A first positive electrode 460 includes two edges 462 with a first length and two edges 464 with a second length, which may be greater than the first length. The first positive electrode 460 has two first electrically conductive tabs 466. One tab 466 is disposed on each of two edges 464 having the second length. Thus, the first electrically conductive tabs 466 are disposed on two of four lateral edges of the first positive electrode 460, so that two lateral edges 462 are free of any tabs. Each of the tabs 466 on the first edge 464 are positioned at a location corresponding to a first side 468 of the respective edge 464.

Also shown is a second positive electrode 470. In certain variations, the second positive electrode 470 may comprise a distinct active material from the first positive electrode 460. A second positive electrode 470 includes two edges 472 with a first length and two edges 474 with a second length, which may be greater than the first length. The second positive electrode 470 has two first electrically conductive tabs 476. One tab 476 is disposed on each of two edges 474 having the second length. Thus, the first electrically conductive tabs 476 are disposed on two of four lateral edges of the second positive electrode 470, so that two lateral edges 472 are free of any tabs. The tabs 476 on the first edge 474 are positioned at a location corresponding to a first side 478 of the respective edge 474.

A separator 480 is included. A third electrode 490 includes two edges 492 with a first length and two edges 494 with a second length optionally greater than the first length. The third negative electrode 490 has two third electrically conductive tabs 496. One tab 496 is disposed on each of two edges 494 having the second length. Thus, the third electrically conductive tabs 496 are disposed on two of four lateral edges of the third negative electrode 390, so that two edges are free of any tabs. Two tabs 496 on the two edges 494 with the second length are positioned at a location on a first side 498.

A fourth negative electrode 500 includes two edges 502 with a first length and two edges 504 with a second length optionally greater than the first length. The fourth negative electrode 500 may comprise a distinct active material from the third negative electrode 490. The fourth negative electrode 500 has two fourth electrically conductive tabs 506. One tab 506 is disposed on each of two edges 504 having the second length. Thus, the fourth electrically conductive tabs 506 are disposed on two of four lateral edges, so that two edges 502 are free of and do not have any tabs. Two tabs 506 on the two edges 504 with the second length are positioned at a location on a first side 508.

The first positive electrode 460, the second positive electrode 470, the separator 480, the third negative electrode 490, and the fourth negative electrode 500 are then stacked together to form a core cell assembly 510. In the core assembly 510, edges 512 having the second length define a position at a first side 514 and a position at a second side 516. The first side 514 corresponds to the first side 468 of first positive electrode 460 and first side 478 of the second positive electrode 470. The plurality of the first electrically conductive tabs 466 of the first positive electrode 460 substantially align with the plurality of second electrically conductive tabs 476 of the second positive electrode 470 on the first side 514 when they are assembled together (e.g., stacked) and thus form common positive tabs 518. Likewise, edges 512 having the second length include the plurality of third electrically conductive tabs 496 of the third negative electrode 490 substantially aligned with the plurality of fourth electrically conductive tabs 506 of the fourth negative electrode 500 on the second side 516. When they are assembled (e.g., stacked) they form thus form common negative tabs 520.

The core cell assembly 510 then is incorporated into and forms the capacitor-assisted hybrid lithium-ion electrochemical cell assembly 450. The common positive tabs 518 may be welded together and appropriately capped or sheathed to form a plurality of positive electrical connectors 530. The positive electrical connectors 530 may be connected to other electrical conduits with the same polarity, such as bus bars, circuitry, or may themselves form terminals for external connection to loads, generators, or power sources and the like. Similarly, the common negative tabs 520 may be welded together and appropriately capped or sheathed to form a plurality of negative electrical connectors 532. The negative electrical connectors 532 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 450 can be incorporated into other components, such as a housing or pouch 540 prior to or after forming the positive electrical connector 530 and negative electrical connector 532.

Two parallel lateral edges 534 of the four edges of the capacitor-assisted hybrid lithium-ion electrochemical cell assembly 450 have both a positive electrical connector 530 and a spaced apart negative electrical connector 532 (corresponding to the first side 514 and second side 516 of each lateral edge 512). Further, each of opposing lateral edges 536 is free of any tabs. Thus, two opposite edges of the electrochemical cell assembly have both a positive electrical connector and a spaced apart negative electrical connector to define a four-tab hybrid design.

The plurality of positive and negative electrical connectors 530, 532 on two edges of the electrochemical cell serves to distribute current more uniformly during operation and lithium ion cycling, thus minimizing variations in current and minimizing current density within the high powered cell. By including four tabs integrally formed with and connected to positive or negative electrical connectors on two opposing parallel lateral edges of the electrochemical cell assembly, current and current density carried by any one of the tabs is improved for better thermal distribution, especially during high power charge and discharge conditions.

The capacitor-assisted hybrid lithium-ion electrochemical cell assembly 450 may be formed by a continuous electrode coating process where tabs can be created on two sides of a continuously deposited electrode that is intermittently cut at appropriate intervals. Alternatively, the capacitor-assisted hybrid lithium-ion electrochemical cell assembly 450 may be formed by an intermittent coating process forming discrete electrodes on a current collector foil, where the tabs are notched into each respective discrete electrode in the appropriate positions along lateral edges.

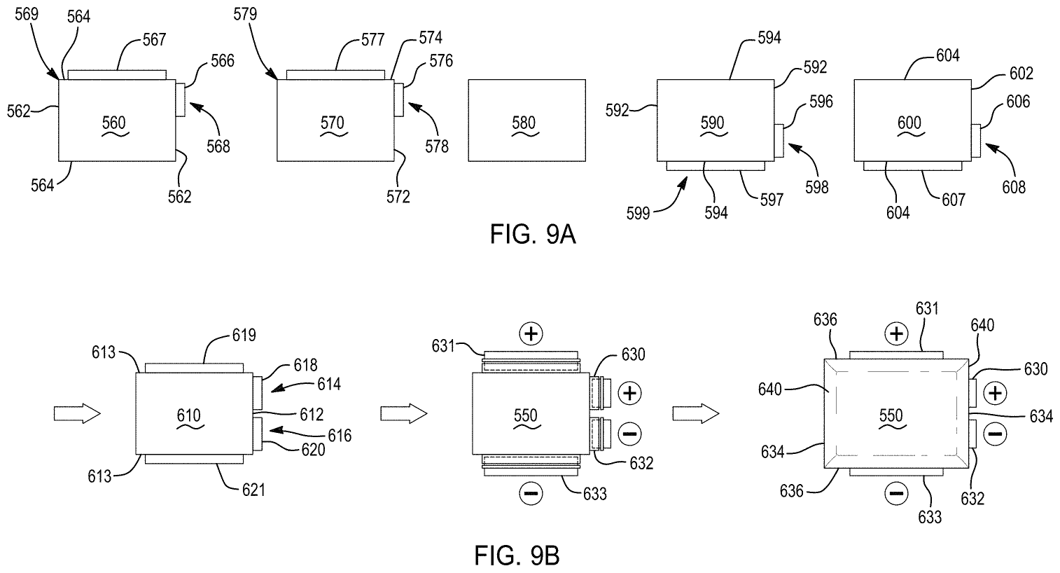

FIGS. 9A-9B show components of another variation of a capacitor-assisted hybrid lithium-ion electrochemical cell assembly 550 prepared in accordance with certain aspects of the present disclosure having electrode components with tabs on two distinct, but adjoining edges. For brevity, unless otherwise specifically addressed, the components of the capacitor-assisted hybrid lithium-ion electrochemical cell assembly 550 having the same design, function, and/or dimensions as those in the capacitor-assisted hybrid lithium-ion electrochemical cell assembly 150 in FIGS. 4A-4B previously described will not be described again in detail, but will be understood to share the same properties and dimensions as discussed above.

A first positive electrode 560 includes two edges 562 with a first length and two edges 564 with a second length, which may be greater than the first length. Notably, each of the edge 562 with the first length is adjoining or adjacent to an edge 564 with a second length, meaning that they connect at edge corners. The first positive electrode 560 has a first electrically conductive tab 566 on edge 562 with the first length. Further, the first positive electrode 560 has a second electrically conductive tab 567 on edge 564 with the second length. Thus, the first and second electrically conductive tabs 566, 567 are disposed on two of four adjoining lateral edges of the first positive electrode 560, so that two other adjoining lateral edges 562, 564 are free of any tabs. Tab 566 is positioned at a location corresponding to a first side 568 of the respective edge 562. Tab 567 is centrally positioned on edge 564, but leaves terminal ends of the edge 564 near corners 569 unoccupied.

Tab 566 occupies less than half of the length of an edge 562 of the first positive electrode 560, for example, a tab width may be greater than or equal to about 20% to less than or equal to about 45% of an overall length of the edge. In certain aspects, a height of the tab 566 may be greater than or equal to about 5 mm to less than or equal to about 30 mm. In certain other aspects, a width of the tab 566 may be greater than or equal to about 30 mm to less than or equal to about 300 mm. Each tab 567 occupies more than half an overall length of edge 564, for example, a tab 567 length may be greater than or equal to about 50% to less than or equal to about 90% of an overall length of the edge. In certain aspects, a height of the tab 567 may be greater than or equal to about 5 mm to less than or equal to about 30 mm. In certain other aspects, a width of the tab 567 may be greater than or equal to about 50 mm to less than or equal to about 600 mm. Thus, tab 566 can be considered to be a small tab for lower power applications, while tab 567 can be considered to be a large tab for high power applications. Tabs 566 and 567 may vary in dimensions and shape from those shown in FIGS. 9A and 9B.

Also shown is a second positive electrode 570 that may comprise a distinct active material from the first positive electrode 560. The second positive electrode 570 includes two edges 572 with a first length and two edges 574 with a second length, which may be greater than the first length. Notably, each of the edge 572 with the first length is adjoining or adjacent to an edge 574 with a second length, meaning that they connect or adjoin at edge corners. The second positive electrode 570 has a first electrically conductive tab 576 on edge 572 with the first length. Further, the second positive electrode 570 has a second electrically conductive tab 567 on edge 574 with the second length. Thus, the first and second electrically conductive tabs 576, 577 are disposed on two of four adjoining lateral edges of the second positive electrode 570, so that two other adjoining lateral edges 572, 574 are free of any tabs. Tab 576 is positioned at a location corresponding to a first side 578 of the respective edge 572. Tab 577 is centrally positioned on edge 574, but leaves terminal ends of the edge 574 near corners 579 unoccupied. Tabs 576 and 577 may have the same sizing and dimensions as tabs 566 and 567 in first positive electrode 560 and for brevity will not be described again herein.

A separator 580 is included. A third negative electrode 590 includes two edges 592 with a first length and two edges 594 with a second length, which may be greater than the first length. Notably, each of the edge 592 with the first length is adjoining or adjacent to an edge 594 with a second length, meaning that they connect or adjoin at edge corners. The third negative electrode 590 has a first electrically conductive tab 596 on edge 592 with the first length. Further, the third negative electrode 590 has a second electrically conductive tab 597 on edge 594 with the second length. Thus, the first and second electrically conductive tabs 596, 597 are disposed on two of four adjoining lateral edges of the third negative electrode 590, so that two other adjoining lateral edges 592, 594 are free of any tabs. Tab 596 is positioned at a location corresponding to a first side 598 of the respective edge 592. Tab 597 is centrally positioned on edge 594, but leaves terminal ends of the edge 594 near corners 599 unoccupied. While the positioning may be on distinct regions of the edge, tabs 596 and 597 may have the same sizing and dimensions as tabs 566 and 567 in first positive electrode 560 and for brevity will not be described again herein.

A fourth negative electrode 600 may comprise a distinct active material from the third negative electrode 590. The fourth negative electrode 600 includes two edges 602 with a first length and two edges 604 with a second length optionally greater than the first length. Each of the edge 602 with the first length is adjoining or adjacent to an edge 604 with a second length, meaning that they connect or adjoin at edge corners. The fourth negative electrode 600 has a first electrically conductive tab 606 on edge 602 with the first length. Further, the fourth negative electrode 600 has a second electrically conductive tab 607 on edge 604 with the second length. Thus, the first and second electrically conductive tabs 606, 607 are disposed on two of four adjoining lateral edges of the electrode 600, so that two other adjoining lateral edges 602, 604 are free of any tabs. Tab 606 is positioned at a location corresponding to a first side 608 of the respective edge 602. Tab 607 is centrally positioned on edge 604, but leaves terminal ends of the edge 604 near corners 609 unoccupied. While the positioning may be on distinct regions of the edge, again tabs 606 and 607 may have the same sizing and dimensions as tabs 566 and 567 in first positive electrode 560 and for brevity will not be described again herein.

The first positive electrode 560, the second positive electrode 570, the separator 580, the third negative electrode 590, and the fourth negative electrode 600 are then stacked together to form a core cell assembly 610. In the core assembly 610, edges 612 having the first length define a position at a first side 614 and a position at a second side 616. The first side 614 corresponds to the first side 568 of first positive electrode 560 and first side 578 of the second positive electrode 570. The plurality of the first electrically conductive tabs 566 of the first positive electrode 560 substantially align with the plurality of second electrically conductive tabs 576 of the second positive electrode 570 on the first side 614 when they are assembled together (e.g., stacked) and thus form a first common positive tab 618. Similarly, edges 613 having the second length include the second electrically conductive tabs 567 of the first positive electrode 560 that substantially align with the plurality of second electrically conductive tabs 577 of the second positive electrode 570 on the first side 614 when they are assembled together (e.g., stacked) and thus form a second common positive tab 619 on one edge 613.

The edge 612 having the first common positive tab 618 also has a first common negative tab 620. The first common negative tab 620 is formed by substantially aligning the plurality of third electrically conductive tabs 596 of the third negative electrode 590 with the plurality of fourth electrically conductive tabs 606 of the fourth negative electrode 600. Likewise, one edge 613 having the second length includes a second common negative tab 621. The second common negative tab 621 is formed by substantially aligning the third electrically conductive tabs 597 of the third negative electrode 590 with the fourth electrically conductive tab 607 of the fourth negative electrode 600 when they are assembled together (e.g., stacked).

The core cell assembly 610 then is incorporated into and forms the capacitor-assisted hybrid lithium-ion electrochemical cell assembly 550. The respective layers within the first common positive tab 618 may be welded together and appropriately capped or sheathed to form a first positive electrical connector 630. Likewise, the second common positive tab 619 layers may be welded together and appropriately capped or sheathed to form a second positive electrical connector 631. The positive electrical connectors 630, 631 may be connected to other electrical conduits with the same polarity, such as bus bars, circuitry, or may themselves form terminals for external connection to loads, generators, or power sources and the like. Similarly, the first common negative tabs 620 may be welded together and appropriately capped or sheathed to form a first negative electrical connector 632. Likewise, the second common negative tab 621 layers may be welded together and appropriately capped or sheathed to form a second negative electrical connector 633. The negative electrical connectors 632, 633 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 550 can be incorporated into other components, such as a housing or pouch 640 prior to or after forming the positive electrical connectors 630, 631 and negative electrical connectors 632, 633.

One lateral edge 634 of the four edges of the capacitor-assisted hybrid lithium-ion electrochemical cell assembly 550 has both the positive electrical connector 630 and a spaced apart negative electrical connector 632 (corresponding to the first side 614 and second side 616 of each lateral edge 612). Additionally, two parallel edges 636 that are respectively adjoining to the lateral edge 634 have either the positive electrical connectors 631 or the negative electrical connector 633. Further, opposing lateral edges 634 is free of any tabs. As shown, positive electrical connector 630 and negative electrical connector 632 on lateral edge 634 are relatively small electrical connectors suitable for low power applications, while the positive electrical connectors 631 or the negative electrical connector 633 on sides 636 are of a relatively large size for higher power applications.

By including four tabs integrally formed with and connected to positive or negative electrical connectors on four lateral edges of the electrochemical cell assembly, current and current density carried by any one of the tabs are minimized, which is particularly advantageous for ultra-high power applications. This in turns serves to reduce hot spots and diminish thermal gradients during high power charge and discharge conditions.

The capacitor-assisted hybrid lithium-ion electrochemical cell assembly 550 may be formed by an intermittent coating process forming discrete electrodes on a current collector foil, where the tabs are notched into each respective discrete electrode in the appropriate positions along lateral edges.

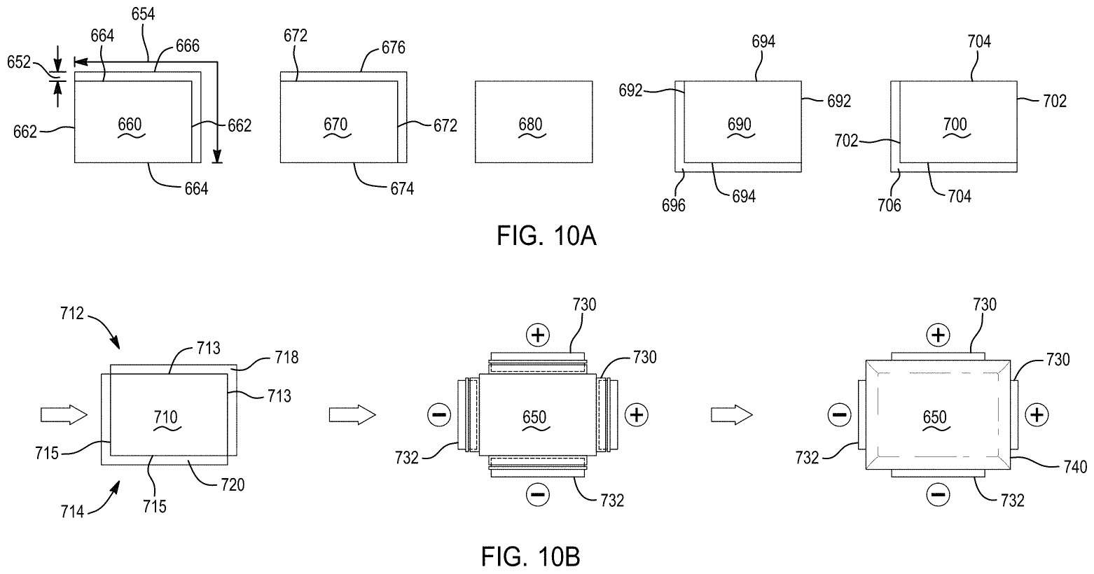

FIGS. 10A-10B show components of another variation of a capacitor-assisted hybrid lithium-ion electrochemical cell assembly 650 prepared in accordance with certain aspects of the present disclosure having electrode components with tabs continuous L-shaped tabs on two adjoining edges. Again, unless otherwise specifically addressed, the components of the capacitor-assisted hybrid lithium-ion electrochemical cell assembly 650 having the same design, function, and/or dimensions as those in the capacitor-assisted hybrid lithium-ion electrochemical cell assembly 150 in FIGS. 4A-4B previously described will not be described again in detail, but will be understood to share the same properties and dimensions as discussed above.

A first positive electrode 660 includes two edges 662 with a first length and two edges 664 with a second length, which may be greater than the first length. Notably, each of the edges 662 with the first length is adjoining or adjacent to an edge 664 with a second length, meaning that they are physically connected to one another at edge corners. The first positive electrode 660 thus has a first electrically conductive tab 666 that is L-shaped and extends along one first edge 662 with the first length and one second edge 664. Tab 666 occupies a majority or all of the length of both edge 662 and edge 664, for example, an overall tab length for the L-shaped may be greater than or equal to about 60% to less than or equal to about 100% of an overall cumulative length of the both edge 662 and 664. In certain variations, a width of the L-shaped tab 666 is co-extensive with a length of edge 662 and edge 664. In certain aspects, a height 652 of the tab 666 may be greater than or equal to about 5 mm to less than or equal to about 30 mm. In certain other aspects, a width 654 of the tab 666 (as it extends over adjoining edges 662, 664) may be greater than or equal to about 50 mm to less than or equal to about 600 mm. A remaining first edge 662 and second edge 664 do not have any tabs.

Also shown is a second positive electrode 670 that may comprise a distinct active material from the first positive electrode 660. The second positive electrode 670 includes two edges 672 with a first length and two edges 674 with a second length, which may be greater than the first length. Notably, each of the edges 672 with the first length is adjoining or adjacent to an edge 674 with a second length, meaning that they are physically connected at edge corners. The second positive electrode 670 has a second electrically conductive tab 676 that is L-shaped and extends along one first edge 672 with the first length and one second edge 674. Tab 676 occupies a majority or all of the length of both edge 672 and edge 674 in a similar manner to tab 666 described in the context of the first positive electrode 660 and may have the same dimensions. Remaining first edge 672 and second edge 674 do not have any tabs.

A separator 680 is included. A third negative electrode 690 includes two edges 692 with a first length and two edges 694 with a second length, which may be greater than the first length. Edges 692 with the first length are adjoining or adjacent to edges 694 with a second length, meaning that they connect or adjoin at edge corners. The third negative electrode 690 has a third electrically conductive tab 696 that is L-shaped and extends along one first edge 692 with the first length and one second edge 694. Tab 696 occupies a majority or all of the length of both edge 692 and edge 694 in a similar manner to tab 666 and have the same dimensions as described in the context of the first positive electrode 660. However, third electrically conductive tab 696 is disposed on an opposite side and thus opposite edges of the electrode as compared to placement of tab 666 in first positive electrode 660. Remaining first edge 692 and second edge 694 do not have any tabs. Again, the edges free of tabs in the third negative electrode 690 are in diametrically opposite positions to the edges free of tabs in the first and second positive electrodes 660, 670.

A fourth negative electrode 700 may have a distinct active material from the third negative electrode 690. The fourth negative electrode 700 includes two edges 702 with a first length and two edges 704 with a second length, which may be greater than the first length. Edges 702 with the first length are adjoining or adjacent to edges 704 with a second length, meaning that they connect or adjoin at edge corners. The fourth negative electrode 700 has a fourth electrically conductive tab 706 that is L-shaped and extends along one first edge 702 with the first length and one second edge 704. Tab 706 occupies a majority or all of the length of both edge 702 and edge 704 in a similar manner to tab 666 described in the context of the first positive electrode 660. However, fourth electrically conductive tab 706 is disposed on an opposite side and thus opposite edges of the electrode as compared to placement of tab 666 in first positive electrode 660. Remaining first edge 702 and second edge 704 do not have any tabs. Again, the edges free of tabs in the fourth negative electrode 700 are in diametrically opposite positions to the edges free of tabs in the first and second positive electrodes 660, 670.

The first positive electrode 660, the second positive electrode 670, the separator 680, the third negative electrode 690, and the fourth negative electrode 700 are then stacked together to form a core cell assembly 710. In the core assembly 710, the first electrically conductive L-shaped tab 666 of the first positive electrode 660 substantially aligns with the second electrically conductive L-shaped tab 676 of the second positive electrode 670 on a first side 612 of the core cell assembly 710 when they are assembled together (e.g., stacked). Similarly, on a second side 714 of the core cell assembly 710 diametrically opposed to the first side 712, the third electrically conductive L-shaped tab 696 of the third negative electrode 690 substantially aligns with the fourth electrically conductive L-shaped tab 706 of the second positive electrode 700. As shown, a common positive tab 718 is formed on adjoining edges 713 from a portion of the joined first electrically conductive L-shaped tab 666 and the second electrically conductive L-shaped tab 676. Further, two distinct common negative tabs 720 are formed on adjoining edges 715 from a portion of the joined third electrically conductive L-shaped tab 696 and the fourth electrically conductive L-shaped tab 706.

The core cell assembly 710 then is incorporated into and forms the capacitor-assisted hybrid lithium-ion electrochemical cell assembly 650. Select regions of respective layers within the first common positive tab 718 may be welded in select regions and appropriately capped or sheathed to form a plurality of positive electrical connectors 730. The positive electrical connectors 730 may be connected to other electrical conduits with the same polarity, such as bus bars, circuitry, or may themselves form terminals for external connection to loads, generators, or power sources and the like. Similarly, the first common negative tab 720 may be welded together in select regions and appropriately capped or sheathed to form a plurality of negative electrical connectors 732. The negative electrical connector 732 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 650 can be incorporated into other components, such as a housing or pouch 740 prior to or after forming the positive electrical connectors 730 and negative electrical connectors 732.

As shown in the design in FIGS. 10A-10B, four large tabs that are asymmetric are included for enhanced current distribution. Further, using intermittent coated electrodes and large areas of foil in the form of tabs can provide lower cell resistance and better thermal distribution. Thus, a capacitor-assisted hybrid lithium-ion electrochemical cell assembly 650 has a plurality of positive electrical connectors and a plurality of negative electrical connectors, where a first edge has a positive electrical connector, an adjoining second edge has a negative electrical connector, a third edge has negative electrical connector, and a fourth edge has a positive electrical connector. In this design, a first pair of opposite edges have a positive electrical connector and a negative electrical connector. Further, a second pair of opposite edges also have a positive electrical connector and an opposite negative electrical connector. By including four tabs integrally formed with and connected to positive or negative electrical connectors on four lateral edges of the electrochemical cell assembly, current and current density carried by any one of the tabs are minimized, which is particularly advantageous for ultra-high power applications. This in turns serves to reduce hot spots and diminish thermal gradients during high power charge and discharge conditions.

The capacitor-assisted hybrid lithium-ion electrochemical cell assembly 650 may be formed by an intermittent coating process forming discrete electrodes on a current collector foil, where the tabs are notched into each respective discrete electrode in the appropriate positions along lateral edges.

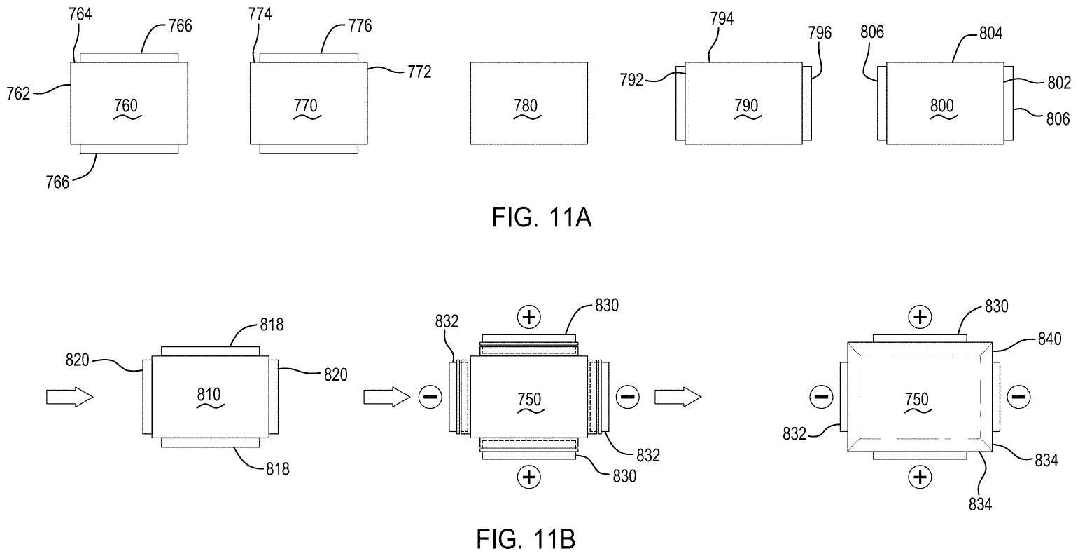

FIGS. 11A-11B show components of a capacitor-assisted hybrid lithium-ion electrochemical cell assembly 750 prepared in accordance with certain aspects of the present disclosure having positive electrode components with tabs on two distinct opposing edges and negative electrode components with tabs on two distinct opposing edges.

A first positive electrode 760 includes two edges 762 with a first length and two edges 764 with a second length, which may be greater than the first length. A plurality of first electrically conductive tabs 766 extend along the edges 764. Tabs 766 occupies a majority or all of the length of edge 764, for example, an overall tab length for the tab may be greater than or equal to about 50% to less than or equal to about 100% of an overall cumulative length of the edge 764. Remaining first edges 762 do not have any tabs.

Also shown is a second positive electrode 770 that may comprise a distinct active material from the first positive electrode 760. The second positive electrode 770 includes two edges 772 with a first length and two edges 774 with a second length, which may be greater than the first length. A plurality of second electrically conductive tabs 776 extend along the edges 774, like tab 766 above. Remaining first edges 772 do not have any tabs.

A separator 780 is included. A third negative electrode 790 includes two edges 792 with a first length and two edges 794 with a second length, which may be greater than the first length. A plurality of third electrically conductive tabs 796 extend along the edges 792 and have dimensions similar to tab 766 described above. Remaining first edges 794 do not have any tabs.

A fourth negative electrode 800 includes two edges 802 with a first length and two edges 804 with a second length, which may be greater than the first length. A plurality of fourth electrically conductive tabs 806 extend along the edges 802 and have dimensions similar to tab 766 described above. Remaining first edges 804 do not have any tabs.

The first positive electrode 760, the second positive electrode 770, the separator 780, the third negative electrode 790, and the fourth negative electrode 800 are then stacked together to form a core cell assembly 810. In the core assembly 810, the plurality of the first electrically conductive tabs 766 of the first positive electrode 760 substantially align with the plurality of second electrically conductive tabs 776 of the second positive electrode 770 when they are assembled together (e.g., stacked) and thus form first common positive tabs 818. Similarly, common negative tabs 820 are formed by substantially aligning the third electrically conductive tabs 796 of the third negative electrode 790 with the fourth electrically conductive tab 806 of the fourth negative electrode 800 when they are assembled together (e.g., stacked).

The core cell assembly 810 then is incorporated into and forms the capacitor-assisted hybrid lithium-ion electrochemical cell assembly 750. The respective layers within the common positive tabs 818 may be welded together and appropriately capped or sheathed to form a first positive electrical connector 830. The positive electrical connectors 630 may be connected to other electrical conduits with the same polarity, such as bus bars, circuitry, or may themselves form terminals for external connection to loads, generators, or power sources and the like. Similarly, the common negative tabs 820 may be welded together and appropriately capped or sheathed to form a first negative electrical connector 832. The negative electrical connectors 832 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 750 can be incorporated into other components, such as a housing or pouch 840 prior to or after forming the positive electrical connectors 830 and negative electrical connectors 832.

Each lateral edge 834 of the four edges of the capacitor-assisted hybrid lithium-ion electrochemical cell assembly 750 has either the positive electrical connector 830 or negative electrical connector 832. Thus, a first pair is defined by one positive electrical connector 830 diametrically opposed by one negative electrical connector, while a second pair is also defined by a different positive electrical connector 830 diametrically opposed to a different negative electrical connector 830. The capacitor-assisted hybrid lithium-ion electrochemical cell assembly 750 has a first edge with a positive electrical connector, an adjoining second edge with a negative electrical connector, a third edge with a positive electrical connector, and a fourth edge with a negative electrical connector, so that a first pair of opposite edges have a positive electrical connector and an opposite positive electrical connector and a second pair of opposite edges also have a negative electrical connector and an opposite negative electrical connector. By including four large tabs integrally formed with and connected to positive or negative electrical connectors disposed on four lateral and opposing edges of the electrochemical cell assembly, current and current density carried by any one of the tabs are minimized, which is particularly advantageous for ultra-high power applications. This in turns serves to reduce hot spots and diminish thermal gradients during high power charge and discharge conditions.

The capacitor-assisted hybrid lithium-ion electrochemical cell assembly 750 may be formed by an intermittent coating process forming discrete electrodes on a current collector foil, where the tabs are notched into each respective discrete electrode in the appropriate positions along lateral edges.

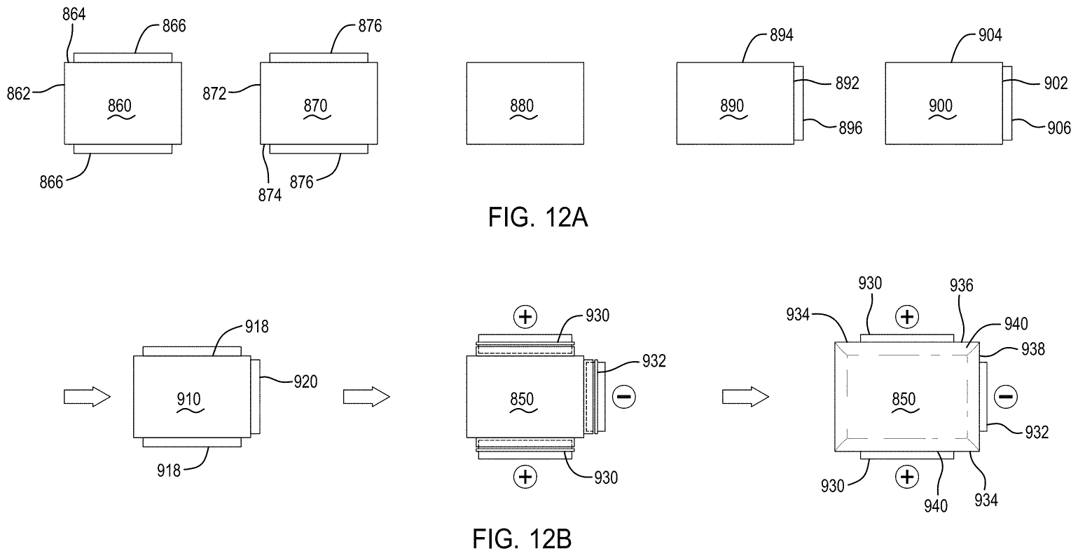

FIGS. 12A-12B show components of a capacitor-assisted hybrid lithium-ion electrochemical cell assembly 850 prepared in accordance with certain aspects of the present disclosure having positive electrode components with tabs on two distinct opposing edges and negative electrode components with tabs on one edge. The first positive electrode 860 includes two edges 862 with a first length and two edges 864 with a second length, which may be greater than the first length. A plurality of first electrically conductive tabs 866 extend along the edges 864. Tabs 866 occupy a majority or all of the length of edge 864, for example, an overall tab length for the tab may be greater than or equal to about 50% to less than or equal to about 100% of an overall cumulative length of the edge 864. In certain aspects, a height of the tab 866 may be greater than or equal to about 5 mm to less than or equal to about 30 mm. In certain other aspects, a width of the tab 866 may be greater than or equal to about 50 mm to less than or equal to about 600 mm. Remaining first edges 862 do not have any tabs.

Also shown is a second positive electrode 870 that may comprise a distinct active material from the first positive electrode 860. The second positive electrode 870 includes two edges 872 with a first length and two edges 874 with a second length, which may be greater than the first length. A plurality of second electrically conductive tabs 876 extend along the edges 874, like tab 866 above and may share the same dimensions. Remaining first edges 872 do not have any tabs.

A separator 780 is included. A third negative electrode 890 includes two edges 892 with a first length and two edges 894 with a second length, which may be greater than the first length. A third electrically conductive tab 896 extends along the edge 892 and has dimensions similar to tab 866 described above. The other edge 892 and edges 894 do not have any tabs.

A fourth negative electrode 900 includes two edges 902 with a first length and two edges 904 with a second length, which may be greater than the first length. A fourth electrically conductive tab 906 extends along one edge 902 and has dimensions similar to tab 866 described above. The other edge 902 and edges 904 do not have any tabs.

The first positive electrode 860, the second positive electrode 870, the separator 880, the third negative electrode 890, and the fourth negative electrode 900 are then stacked together to form a core cell assembly 910. In the core assembly 910, the plurality of the first electrically conductive tabs 866 of the first positive electrode 860 substantially align with the plurality of second electrically conductive tabs 876 of the second positive electrode 870 when they are assembled together (e.g., stacked) and thus form first common positive tabs 918. Similarly, a common negative tab 920 is formed by substantially aligning the third electrically conductive tab 896 of the third negative electrode 890 with the fourth electrically conductive tab 906 of the fourth negative electrode 900 when they are assembled together (e.g., stacked).

The core cell assembly 910 then is incorporated into and forms the capacitor-assisted hybrid lithium-ion electrochemical cell assembly 850. The respective layers within the common positive tabs 918 may be welded together and appropriately capped or sheathed to form a first positive electrical connector 930. The positive electrical connectors 930 may be connected to other electrical conduits with the same polarity, such as bus bars, circuitry, or may themselves form terminals for external connection to loads, generators, or power sources and the like. Similarly, the common negative tabs 920 may be welded together and appropriately capped or sheathed to form a first negative electrical connector 932. The negative electrical connectors 932 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 850 can be incorporated into other components, such as a housing or pouch 940 prior to or after forming the positive electrical connectors 930 and negative electrical connectors 932.

Three lateral edges 934 of the four edges of the capacitor-assisted hybrid lithium-ion electrochemical cell assembly 850 has either the positive electrical connector 930 or negative electrical connector 932. The capacitor-assisted hybrid lithium-ion electrochemical cell assembly 850 has a first edge 936 with a positive electrical connector 930, an adjoining second edge 938 with a negative electrical connector 932, a third edge 940 with a positive electrical connector 930. A remaining edge is free of any electrical connectors. By including two positive electrical connectors and one negative electrical connector, this electrochemical cell assembly design decreases internal positive terminal temperatures and thermal gradients. This may be particularly advantageous in design where one of the positive electrodes includes a capacitor active material.

The capacitor-assisted hybrid lithium-ion electrochemical cell assembly 850 may be formed by a continuous electrode coating process where tabs can be created on one or two sides of a continuously deposited electrode that is intermittently cut at appropriate intervals. Alternatively, the capacitor-assisted hybrid lithium-ion electrochemical cell assembly 850 may be formed by an intermittent coating process forming discrete electrodes on a current collector foil, where the tabs are notched into each respective discrete electrode in the appropriate positions along lateral edges.

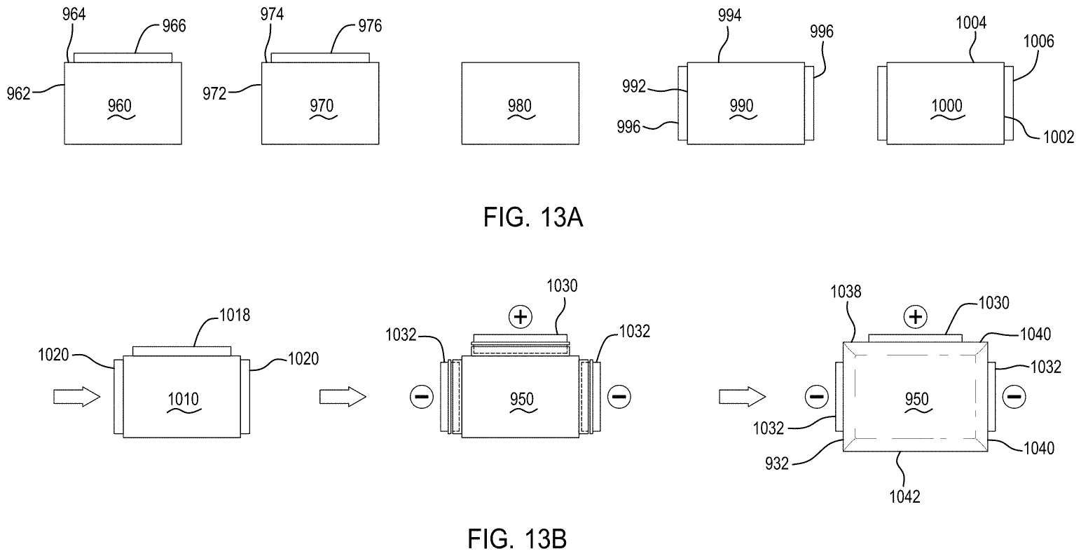

FIGS. 13A-13B show components of a capacitor-assisted hybrid lithium-ion electrochemical cell assembly 950 prepared in accordance with certain aspects of the present disclosure having positive electrode components with a tab on one edge and negative electrode components with tabs on two distinct opposing edges.

A first positive electrode 960 includes two edges 962 with a first length and two edges 964 with a second length, which may be greater than the first length. A first electrically conductive tab 966 extends along the edge 962. The other edge 892 and edges 894 do not have any tabs. Tab 966 occupies a majority or all of the length of edge 964, for example, an overall tab length for the tab may be greater than or equal to about 50% to less than or equal to about 100% of an overall cumulative length of the edge 964. Tab 966 may have the same dimensions as tab 866 described above in the context of first positive electrode 860 in FIG. 12A.

Also shown is a second positive electrode 970 that may comprise a distinct active material from the first positive electrode 960. The second positive electrode 970 includes two edges 972 with a first length and two edges 974 with a second length, which may be greater than the first length. A second electrically conductive tab 976 extends along the edge 972, which may have the same dimensions as tab 966.

A separator 780 is included. The third negative electrode 990 includes two edges 992 with a first length and two edges 994 with a second length, which may be greater than the first length. A plurality of third electrically conductive tabs 996 extend along the edges 992, which may have the same dimensions as tab 966. Remaining first edges 994 do not have any tabs.

A fourth negative electrode 1000 includes two edges 1002 with a first length and two edges 1004 with a second length, which may be greater than the first length. A plurality of fourth electrically conductive tabs 1006 extend along the edges 1002, which may have the same dimensions as tab 966. Remaining first edges 1004 do not have any tabs.

A core cell assembly 1010 is formed by assembling the first positive electrode 960, the second positive electrode 970, the separator 980, the third negative electrode 990, and the fourth negative electrode 1000 together. In the core assembly 1010, the first electrically conductive tab 966 of the first positive electrode 960 substantially aligns with the second electrically conductive tab 976 of the second positive electrode 970 when they are assembled together (e.g., stacked) and thus form first common positive tabs 1018. Similarly, common negative tabs 1020 are formed by substantially aligning the third electrically conductive tabs 996 of the third negative electrode 990 with the fourth electrically conductive tabs 1006 of the fourth negative electrode 1000 when they are assembled together (e.g., stacked).

The core cell assembly 1010 is incorporated into and forms the capacitor-assisted hybrid lithium-ion electrochemical cell assembly 950. The respective layers within the common positive tab 1018 may be welded together and appropriately capped or sheathed to form a first positive electrical connector 1030. The positive electrical connectors 1030 may be connected to other electrical conduits with the same polarity, such as bus bars, circuitry, or may themselves form terminals for external connection to loads, generators, or power sources and the like. Similarly, the common negative tabs 1020 may be welded together and appropriately capped or sheathed to form a first negative electrical connector 1032. The negative electrical connectors 1032 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 950 can be incorporated into other components, such as a housing or pouch 1040 prior to or after forming the positive electrical connectors 1030 and negative electrical connectors 1032.

Three lateral edges of the four edges of the capacitor-assisted hybrid lithium-ion electrochemical cell assembly 950 has either the positive electrical connector 1030 or negative electrical connectors 1032. The capacitor-assisted hybrid lithium-ion electrochemical cell assembly 950 has a first edge 1036 with negative electrical connector 1032, an adjoining second edge 1038 with a positive electrical connector 1030, a third edge 1040 with a negative electrical connector 1032. A remaining edge 1042 is free of any electrical connectors. By including one positive electrical connectors and two negative electrical connectors, this electrochemical cell assembly design decreases internal negative terminal temperatures and thermal gradients. This may be particularly advantageous in design where one of the negative electrodes includes a capacitor active material.

The capacitor-assisted hybrid lithium-ion electrochemical cell assembly 950 may be formed by a continuous electrode coating process where tabs can be created on one or two sides of a continuously deposited electrode that is intermittently cut at appropriate intervals. Alternatively, the capacitor-assisted hybrid lithium-ion electrochemical cell assembly 950 may be formed by an intermittent coating process forming discrete electrodes on a current collector foil, where the tabs are notched into each respective discrete electrode in the appropriate positions along lateral edges.

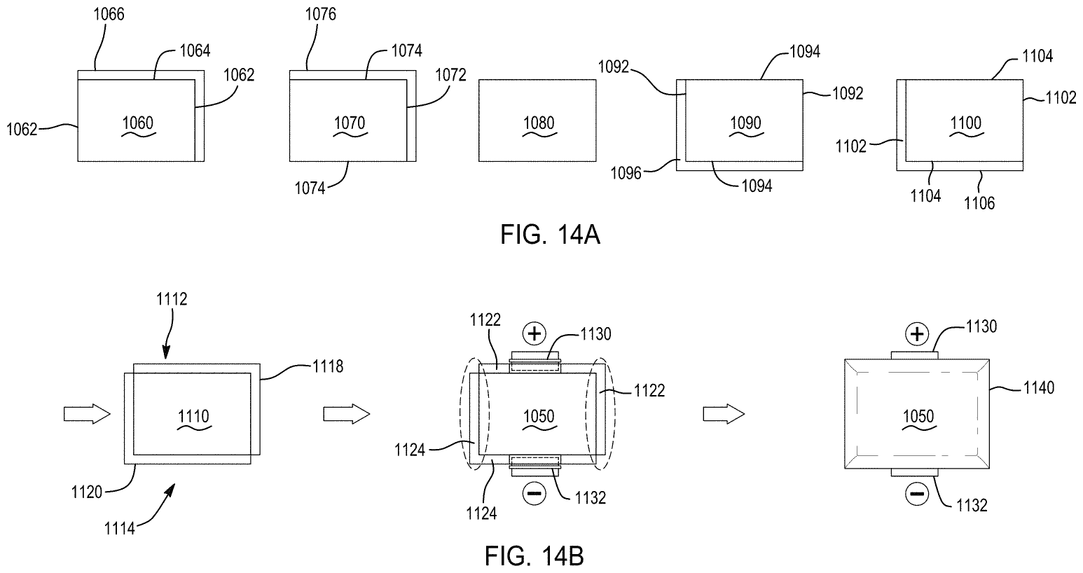

FIGS. 14A-14B show components of a prismatic lithium-ion capacitor-assisted hybrid lithium-ion electrochemical cell assembly 1050 prepared in accordance with certain aspects of the present disclosure having with continuous L-shaped tabs on two adjoining edges of the positive electrode components and with continuous L-shaped tabs on two adjoining edges of the negative electrode components. FIG. 14B shows assembly of the stack of component in FIG. 14B to form a battery core having a pair of opposite edges have a positive electrical connector and an opposite negative electrical connector, along with cooling foils on edges not having the positive or negative electrical connector. FIGS. 14A-14B have a similar design to the capacitor-assisted hybrid lithium-ion electrochemical cell assembly 650 described in FIGS. 10-10B. Again, unless otherwise specifically addressed, the components of the capacitor-assisted hybrid lithium-ion electrochemical cell assembly 1050 having the same design, function, and/or dimensions as those in the capacitor-assisted hybrid lithium-ion electrochemical cell assembly 150 in FIGS. 4A-4B or in the capacitor-assisted hybrid lithium-ion electrochemical cell assembly 650 in FIGS. 10A-10B previously described, will not be discussed again in detail, but will be understood to share the same properties and dimensions as discussed above.

A first positive electrode 1060 includes two edges 1062 with a first length and two edges 1064 with a second length, which may be greater than the first length. Notably, each of the edges 1062 with the first length is adjoining or adjacent to an edge 1064 with a second length, meaning that they are physically connected to one another at edge corners. The first positive electrode 1060 thus has a first electrically conductive tab 1066 that is L-shaped and extends along one first edge 1062 with the first length and one second edge 1064. Tab 1066 occupies a majority or all of the length of both edge 1062 and edge 1064, for example, an overall tab length for the L-shaped may be greater than or equal to about 50% to less than or equal to about 100% of an overall cumulative length of the both edge 1062 and 1064. In certain variations, a length of the L-shaped tab 1066 is co-extensive with a length of edge 1062 and edge 1064. A remaining first edge 1062 and second edge 1064 do not have any tabs.

Also shown is a second positive electrode 1070 that may comprise a distinct active material from the first positive electrode 1060. The second positive electrode 1070 includes two edges 1072 with a first length and two edges 1074 with a second length, which may be greater than the first length. Notably, each of the edges 1072 with the first length is adjoining or adjacent to an edge 1074 with a second length, meaning that they are physically connected at edge corners. The positive electrode 1070 has a second electrically conductive tab 1076 that is L-shaped and extends along one first edge 1072 with the first length and one second edge 1074. Tab 1076 occupies a majority or all of the length of both edge 1072 and edge 1074 in a similar manner to tab 1066 described in the context of the first positive electrode 1060. Remaining first edge 1072 and second edge 1074 do not have any tabs.

A separator 1080 is included. A third electrode 1090 includes two edges 1092 with a first length and two edges 1094 with a second length, which may be greater than the first length. Edges 1092 with the first length are adjoining or adjacent to edges 1094 with a second length, meaning that they connect or adjoin at edge corners. The third negative electrode 1090 has a third electrically conductive tab 1096 that is L-shaped and extends along one first edge 1092 with the first length and one second edge 1094. Tab 1096 occupies a majority or all of the length of both edge 1092 and edge 1094 in a similar manner to tab 1066 described in the context of the first positive electrode 1060. However, third electrically conductive tab 1096 is disposed on an opposite side and thus opposite edges of the electrode as compared to placement of tab 1066 in first positive electrode 1060, for example. Remaining first edge 1092 and second edge 1094 do not have any tabs. Again, the edges free of tabs in the third negative electrode 1090 are in diametrically opposite positions to the edges free of tabs in the first and second positive electrodes 1060, 1070.

A fourth negative electrode 1100 may have a distinct active material from the third negative electrode 1090. The fourth negative electrode 1100 includes two edges 1102 with a first length and two edges 1104 with a second length, which may be greater than the first length. Edges 1102 with the first length are adjoining or adjacent to edges 1104 with a second length, meaning that they connect or adjoin at edge corners. The fourth negative electrode 1100 has a fourth electrically conductive tab 1106 that is L-shaped and extends along one first edge 1102 with the first length and one second edge 1104. Tab 1106 occupies a majority or all of the length of both edge 1102 and edge 1104 in a similar manner to tab 1066 described in the context of the first positive electrode 1060. However, fourth electrically conductive tab 1106 is disposed on an opposite side and thus opposite edges of the electrode as compared to placement of tab 1066 in first positive electrode 1060. Remaining first edge 1102 and second edge 1104 do not have any tabs. Again, the edges free of tabs in the fourth negative electrode 1100 are in diametrically opposite positions to the edges free of tabs in the first and second positive electrodes 1060, 1070.

The first positive electrode 1060, the second positive electrode 1070, the separator 1080, the third negative electrode 1090, and the fourth negative electrode 1100 are then stacked together to form a core cell assembly 1110. In the core assembly 1110, the first electrically conductive L-shaped tab 1066 of the first positive electrode 1060 substantially aligns with the second electrically conductive L-shaped tab 1076 of the second positive electrode 1070 on a first side 1012 of the core cell assembly 1110 when they are assembled together (e.g., stacked). Similarly, on a second side 1114 of the core cell assembly 1110 diametrically opposed to the first side 1112, the third electrically conductive L-shaped tab 1096 of the third negative electrode 1090 substantially aligns with the fourth electrically conductive L-shaped tab 1106 of the second positive electrode 1100. As shown, a common positive tab 1118 is formed from the joined first electrically conductive L-shaped tab 1066 and the second electrically conductive L-shaped tab 1076. Further, a common negative tab 1120 is formed from a portion of the joined third electrically conductive L-shaped tab 1096 and the fourth electrically conductive L-shaped tab 1106.

The core cell assembly 1110 then is incorporated into and forms the capacitor-assisted hybrid lithium-ion electrochemical cell assembly 1050. Select regions of respective layers within the first common positive tab 1118 may be welded in select regions and appropriately capped or sheathed to form a positive electrical connector 1130. In regions 1122 where the respective layers forming the common positive tab 1118 are not welded together (i.e., regions external to the positive electrical connector 1130), layers of foil can remain exposed and serve as cooling foil along the edges of the electrode. This provides for internal cooling within the electrochemical cell. The positive electrical connectors 1130 may be connected to other electrical conduits with the same polarity, such as bus bars, circuitry, or may themselves form terminals for external connection to loads, generators, or power sources and the like.

Similarly, the common negative tab 1120 may be welded together in select regions and appropriately capped or sheathed to form a negative electrical connector 1132. In regions 1124 where the respective layers forming the common negative tab 1120 are not welded together (i.e., regions external to the positive electrical connector 1132), layers of foil can remain exposed and serve as cooling foil along the edges of the electrode. This further provides for internal cooling within the electrochemical cell. The negative electrical connector 1132 may be connected to other electrical conduits with the same polarity, such as bus bars, circuitry, or may themselves form terminals for external connection to loads, generators, or power sources and the like. The capacitor-assisted hybrid lithium-ion electrochemical cell assembly 1050 can be incorporated into other components, such as a housing or pouch 1140 prior to or after forming the positive electrical connectors 1130 and negative electrical connectors 1132.

Thus, the capacitor-assisted hybrid lithium-ion electrochemical cell assembly 1050 has a positive electrical connector and a negative electrical connector, disposed on opposite sides of the assembly 1150. Further, using intermittent coated electrodes and large areas of foil in the form of tabs can provide lower cell resistance, cooling, and better thermal distribution.

The capacitor-assisted hybrid lithium-ion electrochemical cell assembly 1050 may be formed by an intermittent coating process forming discrete electrodes on a current collector foil, where the tabs are notched into each respective discrete electrode in the appropriate positions along lateral edges.

In various aspects, the present disclosure provides new electrode designs for ultra-high power hybrid electrochemical cells with uniform thermal distribution, which are especially suitable for capacitor-assisted batteries that improve cell power performance and durability. These designs enable oriented current flow. For example, by including more tabs, more pathways for electrons are created within each electrode, so electrons travel less distance through the electrode than in conventional designs.

In certain variations, each electrode in the electrochemical cell assembly may comprise at least one electrically conductive tab that protrudes from at least one edge of the electrode and thus defines a height of greater than or equal to about 5 mm to less than or equal to about 30 mm. In certain other aspects, a width of each tab protruding from an edge of each electrode may be greater than or equal to about 30 mm to less than or equal to about 600 mm, optionally greater than or equal to about 30 mm to less than or equal to about 300 mm or in other variations, optionally greater than or equal to about 50 mm to less than or equal to about 600 mm.

In certain aspects, any given electrode in the capacitor-assisted hybrid lithium-ion electrochemical cells may have a maximum current density of less than or equal to about 300 mA/cm². For example, a maximum current density is less than or equal to about 300 mA/cm² for at least one of the first electrode, the second electrode, the third electrode, or the fourth electrode. In certain variations, each of the first electrode, the second electrode, the third electrode, and the fourth electrode has a maximum current density is less than or equal to about 300 mA/cm². In certain variations, a maximum current density is less than or equal to about 250 mA/cm², optionally less than or equal to about 200 mA/cm², optionally less than or equal to about 150 mA/cm², optionally less than or equal to about 100 mA/cm², and in certain aspects, optionally less than or equal to about 90 mA/cm². In certain aspects, a current density within a respective electrode within the electrochemical cell is between about 0 and less than or equal to about 90 mA/cm². The higher the current (or current density), the larger the thermal gradient. Thus, minimizing the current density serves to favorably reduce thermal gradients.

As noted above, assisted hybrid lithium-ion electrochemical cells prepared in accordance with certain aspects of the present disclosure have a reduced current density compared to a conventional two tab design for a comparative capacitor-assisted hybrid lithium-ion electrochemical cell assembly with the same materials. For example, a maximum current density is decreased by greater than or equal to about 35%, optionally greater than or equal to about 40%, optionally greater than or equal to about 50%, optionally greater than or equal to about 55%, optionally greater than or equal to about 60%, optionally greater than or equal to about 65%, optionally greater than or equal to about 70%, and in certain variations, optionally greater than or equal to about 75%.

In certain other aspects, the hybrid lithium-ion electrochemical cell assemblies prepared in accordance with the present disclosure can provide enhanced thermal management, such as comparatively lower direct current resistance (DCR) and less heat generated. By way of example, where performance of a capacitor-assisted hybrid lithium-ion electrochemical cell assembly prepared in accordance with certain aspects of the present disclosure is compared to a conventional two tab design for a comparative capacitor-assisted hybrid lithium-ion electrochemical cell assembly with the same materials, an electron path within the electrodes is reduced, so that direct current resistance (DCR) is decreased by greater than or equal to about 10%, optionally greater than or equal to about 20%, optionally greater than or equal to about 30%, optionally greater than or equal to about 40%, and in certain variations, optionally greater than or equal to about 50%. The lower the DCR, the less heat generated (e.g., Q=I²Rt, where Q is heat, I is current, R is resistance, and t is time), leading to an electrochemical cell that requires less extensive and simpler thermal management. A reduction in maximum current density favorably reduces thermal gradients, which are affected by charge/discharge currents. Further, more uniform counter-fields of electromagnetic interference (EMI) can be achieved with electrochemical cells prepared in accordance with the present disclosure.

Ultra-high power hybrid electrochemical cells incorporating the electrode designs described in the present disclosure have a longer battery life. In certain variations, a lithium-ion electrochemical cells incorporating an inventive electrode design substantially maintain charge capacity (e.g., performs within a preselected range or other targeted high capacity use) for greater than or equal to about 5,000 hours of battery operation, optionally greater than or equal to about 8,000 hours of battery operation, and in certain aspects, greater than or equal to about 10,000 hours or longer of battery operation (active cycling).

In certain variations, the a lithium-ion electrochemical cells incorporating an inventive electrode design are capable of operating within 20% of target charge capacity for a duration of greater than or equal to about 2 years (including storage at ambient conditions and active cycling time), optionally greater than or equal to about 3 years, optionally greater than or equal to about 4 years, optionally greater than or equal to about 5 years, optionally greater than or equal to about 6 years, optionally greater than or equal to about 7 years, optionally greater than or equal to about 8 years, optionally greater than or equal to about 9 years, and in certain aspects, optionally greater than or equal to about 10 years.

In other variations, the lithium-ion electrochemical cells incorporating an inventive electrode design according to certain aspects of the present disclosure are capable of operating at less than or equal to about 30% change in a preselected target charge capacity (thus having a minimal charge capacity fade) for at least about 2,000 deep discharge cycles, optionally greater than or equal to about 4,000 deep discharge cycles, optionally greater than or equal to about 6,000 deep discharge cycles, optionally greater than or equal to about 8,000 deep discharge cycles, and in certain variations, optionally greater than or equal to about 10,000 deep discharge cycles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A capacitor-assisted hybrid lithium-ion electrochemical cell assembly comprising:
a first positive electrode having a first polarity and at least two first electrically conductive tabs disposed on at least one first edge of the first positive electrode and at least one second edge distinct from the first edge;
a second positive electrode having the first polarity and at least two second electrically conductive tabs disposed on at least one first edge of the second positive electrode and at least one second edge distinct from the first edge;
a third negative electrode having a second polarity opposite to the first polarity and at least two third electrically conductive tabs disposed on at least one first edge of the third negative electrode and at least one second edge distinct from the first edge; and
a fourth negative electrode having the second polarity and at least two fourth electrically conductive tabs disposed on at least one first edge of the fourth negative electrode and at least one second edge distinct from the first edge, wherein the second positive electrode comprises a distinct active material from the first positive electrode and/or the fourth negative electrode comprises a distinct active material from the third negative electrode, and the at least two first electrically conductive tabs and the at least two second electrically conductive tabs are substantially aligned in the electrochemical cell assembly to respectively define a plurality of positive electrical connectors and the at least two third electrically conductive tabs and the at least two fourth electrically conductive tabs are substantially aligned in the electrochemical cell assembly to define a plurality of negative electrical connectors spaced apart from the plurality of positive electrical connectors to reduce current density during high power charging and discharging.

2. The capacitor-assisted hybrid lithium-ion electrochemical cell assembly of claim 1, wherein the at least one first edge of the first positive electrode has a first length and the at least one second edge has a second length greater than the first length;
the at least one first edge of the second positive electrode has the first length and the at least one second edge has the second length;
the at least one first edge of the third negative electrode has the first length and the at least one second edge has the second length; and
the at least one first edge of the fourth negative electrode has the first length and the at least one second edge has the second length; wherein the first positive electrode, the second positive electrode, the third negative electrode, and the fourth negative electrode are assembled together to form the capacitor-assisted hybrid lithium-ion electrochemical cell assembly defining a first cell edge with the first length and a second cell edge with the second length, wherein at least one of the plurality of positive electrical connectors and at least one of the negative electrical connectors is disposed on the first cell edge and at least one of the plurality of positive electrical connectors and at least one of the negative electrical connectors is disposed on the second cell edge of the capacitor-assisted hybrid lithium-ion electrochemical cell assembly.

3. The capacitor-assisted hybrid lithium-ion electrochemical cell assembly of claim 1, wherein either the first positive electrode or third negative electrode comprises a high energy capacity electroactive material and the second positive electrode or the fourth negative electrode comprises a high power capacity electroactive material, wherein the first positive electrode and the third negative electrode define a lithium-ion battery and the second positive electrode and/or the fourth negative electrode define a capacitor.

4. The capacitor-assisted hybrid lithium-ion electrochemical cell assembly of claim 1, wherein the at least two first electrically conductive tabs include four first electrically conductive tabs disposed on each of four edges of the first positive electrode, the at least two second electrically conductive tabs include four second electrically conductive tabs disposed on each of four edges of the second positive electrode, the at least two third electrically conductive tabs include four third electrically conductive tabs disposed on each of four edges of the third negative electrode, and the at least two fourth electrically conductive tabs include four fourth electrically conductive tabs disposed on each of four edges of the fourth negative electrode, wherein the electrochemical cell assembly defines four cell edges that each comprise a positive electrical connector and a negative electrical connector.

5. The capacitor-assisted hybrid lithium-ion electrochemical cell assembly of claim 1, wherein the at least two first electrically conductive tabs include three first electrically conductive tabs disposed on each of three edges of the first positive electrode, the at least two second electrically conductive tabs include three second electrically conductive tabs disposed on each of three edges of the second positive electrode, the at least two third electrically conductive tabs include three third electrically conductive tabs disposed on each of three edges of the third negative electrode, and the at least two fourth electrically conductive tabs include three fourth electrically conductive tabs disposed on each of three edges of the fourth negative electrode, wherein the electrochemical cell assembly defines:
(i) three cell edges comprising both a positive electrical connector and a negative electrical connector; or
(ii) a first cell edge having a positive electrical connector and a negative electrical connector, a second cell edge having a positive electrical connector and a negative electrical connector, a third cell edge having a positive electrical connector, and a fourth cell edge having a negative electrical connector.

6. The capacitor-assisted hybrid lithium-ion electrochemical cell assembly of claim 1, wherein the at least two first electrically conductive tabs comprise three electrically conductive tabs disposed on three edges of the first positive electrode and the at least two second electrically conductive tabs comprise three electrically conductive tabs disposed on three edges of the second positive electrode.

7. The capacitor-assisted hybrid lithium-ion electrochemical cell assembly of claim 1, wherein the at least two third electrically conductive tabs comprise three electrically conductive tabs disposed on three edges of the third negative electrode and the at least two fourth electrically conductive tabs comprise three electrically conductive tabs disposed on three edges of the third negative electrode.

8. The capacitor-assisted hybrid lithium-ion electrochemical cell assembly of claim 1, wherein a maximum current density is less than or equal to about 300 mA/cm² for each of the first positive electrode, the second positive electrode, the third negative electrode, and the fourth negative electrode.

9. The capacitor-assisted hybrid lithium-ion electrochemical cell assembly of claim 1, wherein the first positive electrode comprises a first electroactive material selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₊ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof.

10. The capacitor-assisted hybrid lithium-ion electrochemical cell assembly of claim 1, wherein the second positive electrode comprises a second electroactive material and the fourth negative electrode comprises a fourth electroactive material, wherein at least one of the second electroactive material and the fourth electroactive material is selected from the group consisting of: activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, RuO₂, transition metals, hydroxides of transition metals, MnO₂, NiO, Co₃O₄, Co(OH)₂, Ni(OH)₂, polyaniline (PANI), polypyrrole (PPy), polythiophene (PTh), and combinations thereof.

11. The capacitor-assisted hybrid lithium-ion electrochemical cell assembly of claim 1, wherein the third negative electrode comprises a third negative electrode material selected from the group consisting of: lithium metal, lithium alloy, silicon (Si), silicon alloy, silicon oxide, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof.

12. The capacitor-assisted hybrid lithium-ion electrochemical cell assembly of claim 1, wherein each of the first positive electrode, the second positive electrode, the third negative electrode and the fourth negative electrode respectively comprises a current collector having an electroactive layer disposed thereon, wherein a portion of the current collector defines the plurality of electrically conductive tabs.

13. The capacitor-assisted hybrid lithium-ion electrochemical cell assembly of claim 1, wherein the electrochemical cell assembly comprises at least three positive electrical connectors and at least three negative electrical connectors.

14. A capacitor-assisted hybrid lithium-ion electrochemical cell assembly comprising:
a first positive electrode having a first polarity and at least two first electrically conductive tabs disposed on at least one first edge and at least one a second adjoining edge;
a second positive electrode having the first polarity, comprising a distinct active material from the first positive electrode, and at least two second electrically conductive tabs disposed on at least one first edge and at least one second adjoining edge;
a third negative electrode having a second polarity opposite to the first polarity and at least two third electrically conductive tabs disposed on at least one first edge and at least one second adjoining edge; and
a fourth negative electrode having the second polarity and at least two fourth electrically conductive tabs disposed on at least one first edge and at least one second adjoining edge, wherein the at least two first electrically conductive tabs and the at least two second electrically conductive tabs are substantially aligned in the electrochemical cell assembly to respectively define a plurality of positive electrical connectors and the at least two third electrically conductive tabs and the at least two fourth electrically conductive tabs are substantially aligned in the electrochemical cell assembly to define a plurality of negative electrical connectors spaced apart from the plurality of positive electrical connectors to reduce current density during high power charging and discharging.

15. The capacitor-assisted hybrid lithium-ion electrochemical cell assembly of claim 14, wherein either the first positive electrode or third negative electrode comprises a high energy capacity electroactive material and the second positive electrode or the fourth negative electrode comprises a high power capacity electroactive material, wherein the first positive electrode or and the third negative electrode define a lithium-ion battery and the second positive electrode and the fourth negative electrode define a capacitor.

16. The capacitor-assisted hybrid lithium-ion electrochemical cell assembly of claim 14, wherein the at least two first electrically conductive tabs comprise three electrically conductive tabs disposed on three edges of the first positive electrode and the at least two second electrically conductive tabs comprise three electrically conductive tabs disposed on three edges of the second positive electrode.

17. The capacitor-assisted hybrid lithium-ion electrochemical cell assembly of claim 14, wherein the at least two third electrically conductive tabs comprise three electrically conductive tabs disposed on three edges of the third negative electrode and the at least two fourth electrically conductive tabs comprise three electrically conductive tabs disposed on three edges of the third negative electrode.

18. The capacitor-assisted hybrid lithium-ion electrochemical cell assembly of claim 14, wherein the first positive electrode comprises a first electroactive material selected from the group consisting of: LiNiMnCoO₂, Li(NiₓMn_{y}Co_{z})O₂), where 0≤x≤1, 0≤y≤1, 0≤z≤1, and x+y+z=1, LiNiCoAlO₂, LiNi_{1-x-y}CoₓAl_{y}O₂ (where 0≤x≤1 and 0≤y≤1), LiNiₓMn₁₋ₓO₂ (where 0≤x≤1), LiMn₂O₄, Li₁₋ₓMO₂ (where M is one of Mn, Ni, Co, Al and 0≤x≤1), LiMn₂O₄ (LMO), LiNiₓMn_{1.5}O₄, LiV₂(PO₄)₃, LiFeSiO₄, LiMPO₄ (where M is at least one of Fe, Ni, Co, and Mn), activated carbon, and combinations thereof;
the third negative electrode comprises a third negative electrode material selected from the group consisting of: lithium metal, lithium alloy, silicon (Si), silicon alloy, silicon oxide, hard carbon, soft carbon, graphite, graphene, carbon nanotubes, lithium titanium oxide (Li₄Ti₅O₁₂), tin (Sn), vanadium oxide (V₂O₅), titanium dioxide (TiO₂), titanium niobium oxide (TiₓNb_{y}O_{z} where 0≤x≤2, 0≤y≤24, and 0≤z≤64), ferrous sulfide (FeS), and combinations thereof; and
the second positive electrode comprises a second electroactive material and the fourth negative electrode comprises a fourth electroactive material, wherein at least one of the second electroactive material and/or the fourth electroactive material is selected from the group consisting of: activated carbon, hard carbon, soft carbon, porous carbon materials, graphite, graphene, carbon nanotubes, carbon xerogels, mesoporous carbons, templated carbons, carbide-derived carbons (CDCs), graphene, porous carbon spheres, heteroatom-doped carbon materials, metal oxides of noble metals, RuO₂, transition metals, hydroxides of transition metals, MnO₂, NiO, Co₃O₄, Co(OH)₂, Ni(OH)₂, polyaniline (PANI), polypyrrole (PPy), polythiophene (PTh), and combinations thereof.

19. A capacitor-assisted hybrid lithium-ion electrochemical cell assembly comprising:
a first positive electrode having a first polarity and at least two first electrically conductive tabs disposed on at least one first edge of the first positive electrode and at least one second edge distinct from the first edge;
a second positive electrode having the first polarity and at least two second electrically conductive tabs disposed on at least one first edge of the second positive electrode and at least one second edge distinct from the first edge;
a third negative electrode having a second polarity opposite to the first polarity and at least two third electrically conductive tabs disposed on at least one first edge of the third negative electrode and at least one second edge distinct from the first edge; and
a fourth negative electrode having the second polarity and at least two fourth electrically conductive tabs disposed on at least one first edge of the fourth negative electrode and at least one second edge distinct from the first edge, wherein either the first positive electrode or third negative electrode comprises a high energy capacity electroactive material and the second positive electrode or the fourth negative electrode comprises a high power capacity electroactive material, and the at least two first electrically conductive tabs and the at least two second electrically conductive tabs are substantially aligned in the electrochemical cell assembly to respectively define at least one positive electrical connector and the at least two third electrically conductive tabs and the at least two fourth electrically conductive tabs are substantially aligned in the electrochemical cell assembly to define at least one negative electrical connector to reduce current density during high power charging and discharging.

20. The capacitor-assisted hybrid lithium-ion electrochemical cell assembly of claim 19, wherein the electrochemical cell assembly has at least one cell edge comprising both a positive electrical connector and spaced apart negative electrical connector.
